(19) United States
(12) Patent Application Publication
(10) Pub. No.: US 2026/0350441 A1
(43) Pub. Date: Nov. 5, 2026

(54) SYSTEMS, METHODS, COMPUTER ACCESSIBLE MEDIUM, AND DEVICES FOR MULTI-RESOLUTION BAYESIAN MODELING FOR HIGH-RESOLUTION BEHAVIORAL ANALYSIS

(71) Applicant: New York University, New York, NY (US)

(72) Inventor: ZHONG-LIN LU, New York, NY (US)

(21) Appl. No.: 19/650,674

(22) Filed: Apr. 17, 2026

Related U.S. Application Data
(60) Provisional application No. 63/790,936, filed on Apr. 18, 2025.

(51) Int. Cl. G06N 7/01; G06N 5/04

(52) U.S. Cl. CPC G06N 7/01; G06N 5/04

(57) ABSTRACT

Exemplary systems, methods, and computer accessible medium according to the exemplary embodiments of the present disclosure are provided for estimating at least one latent variable from data. The exemplary systems, methods, and computer accessible medium can receive a plurality of measurement outcomes, and construct a multi-resolution pyramid structure having a plurality of layers at progressively finer resolutions based on the plurality of measurement outcomes, whereas a top layer of the multi-resolution pyramid structure represents latent variables at a coarsest resolution. Using a Bayesian inference framework, it is possible to estimate parameters at the top layer and deviation terms at one or more subsequent layers of the multi-resolution pyramid structure, and generate the estimated latent variable(s) at one or more resolutions based on the estimated parameters and the deviation terms.

### CROSS-REFERENCE TO RELATED APPLICATION(S)

This application relates to and claims priority from U.S. Patent Application No. 63/790,936, filed on Apr. 18, 2025, the entire disclosure of which is incorporated herein by reference.

### STATEMENT REGARDING FEDERALLY FUNDED RESEARCH

This invention was made with government support under EY017491 awarded by National Institutes of Health. The government has certain rights in the invention.

### FIELD OF THE DISCLOSURE

The present disclosure relates to the field of human behavior and performance modeling, and more specifically, to systems, methods, and computer accessible medium for estimating high-resolution latent variables from sparse behavioral data.

### BACKGROUND INFORMATION

Human behavior and performance across diverse tasks can emerge from the interplay of external stimuli and internal cognitive processes. To predict and model these outcomes, researchers employ generative frameworks that use latent variables to capture how the task-relevant cognitive systems process inputs and generate responses (see, e.g., Refs. 4, 23, 36, 42, 60, 67, 68, 81, 83, 85, 86, 100 and 124). Understanding the temporal dynamics, spatial properties, or spectral characteristics of behavior-whether in domains like learning, decision-making, or skill acquisition-demands high-resolution estimates of these latent variables across time, space, or frequency (see, e.g., Refs. 12, 16, 19, 20, 26, 27, 38, 43, 69, 75, 76 96 and 117). However, the variability inherent in human behavior often forces reliance on aggregated data, thus reducing the resolution of these estimates.

Accordingly, there is a need to address and/or improve at least the above-described deficiencies which exist in the previous systems, methods and computer-accessible medium by providing systems, methods and computer-accessible medium for providing, e.g., framework and estimation techniques to derive high-resolution latent variables from behavioral measurements.

### SUMMARY OF EXEMPLARY EMBODIMENTS

The following is intended to be a brief summary of the exemplary embodiments of the present disclosure, and is not intended to limit the scope of the exemplary embodiments.

In some exemplary embodiments of the present disclosure, the exemplary systems, methods, and computer accessible medium can be provided for estimating latent variables from data. The exemplary systems, methods, and computer accessible medium can, e.g., receive a plurality of measurement outcomes, construct a multi-resolution pyramid structure having a plurality of layers at progressively finer resolutions. For example, a top layer of the multi-resolution pyramid structure represents latent variables at a coarsest resolution, estimate, using a Bayesian inference framework, parameters at the top layer and deviation terms at one or more subsequent layers of the multi-resolution pyramid structure, and generate at least one estimated latent variable at one or more resolutions based on the estimated parameters and the deviation terms. The multi-resolution pyramid structure can comprise a parameter pyramid for coarse trends and a difference pyramid for fine-scale deviations, and the exemplary systems, methods, and computer accessible medium can iteratively combine the parameter pyramid and the difference pyramid to recover the at least one estimated latent variable at the one or more resolutions. Further, the Bayesian inference framework can comprise a hierarchical Bayesian model with covariance at the top layer and a hierarchical Bayesian model with variance at the one or more subsequent layers.

In some exemplary embodiments of the present disclosure, the exemplary systems, methods, and computer accessible medium can model covariance among the parameters at the top layer of the parameter pyramid and can model variance without covariance at the one or more subsequent layers using the difference pyramid. A number of blocks at each successive layer of the difference pyramid can double relative to a preceding layer. Additionally, the hierarchical Bayesian model with covariance can comprise a population level, a subject level, and a test level. The exemplary systems, methods, and computer accessible medium can pool information across a plurality of subjects at the population level to reduce variance of the at least one estimated latent variable. Moreover, the exemplary systems, methods, and computer accessible medium can model each measurement outcome of the plurality of measurement outcomes as an outcome of a generative function driven by test conditions and the latent variables. The multi-resolution pyramid structure can represent at least one of a one-dimensional discrete function or a two-dimensional discrete function. The plurality of measurement outcomes can comprise behavioral measurement outcomes from a plurality of subjects, and the at least one estimated latent variable can comprise at least one of a decision variable, a perceptual sensitivity, a memory trace, a perceptual learning threshold, a visual field sensitivity, or a contrast sensitivity value. The at least one estimated latent variable can further comprise one or more perceptual variables (e.g., internal noise estimate, sensory adaptation state, temporal integration window, attentional gain, cue reliability estimate, or spatial uncertainty parameter) across sensory modalities including vision, audition, and touch; memory-related variables (e.g., working memory capacity, short-term memory strength, long-term memory strength, forgetting rate, or memory trace fidelity); learning-related variables (e.g., learning rate, perceptual learning rate, or reward sensitivity parameter); action-related variables (e.g., motor variability, response latency, or action selection bias); and decision-related variables (e.g., response criterion, bias parameter, prior expectation, confidence estimate, drift rate, boundary separation, or non-decision time component). In addition, the at least one estimated latent variable can comprise neural variables (e.g., neural gain or population response variability), modulatory variables (e.g., attentional or neuromodulatory state), or pharmaceutical variables (e.g., drug-induced changes in sensitivity, noise, or response dynamics). Further, the exemplary systems, methods, and computer accessible medium can cause a display arrangement to display the at least one estimated latent variable.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1(a) is an exemplary illustration of a parameter pyramid [symbol] _{θ}, where only the value at the top layer is specified, according to an exemplary embodiment of the present disclosure;

FIG. 1(b) is an exemplary illustration of a difference pyramid [symbol] _{δ}, with each pair of respective dots representing a difference value and its negative counterpart, according to an exemplary embodiment of the present disclosure;

FIG. 1(c) is an exemplary illustration of a resulting parameter pyramid [symbol] _{θ}, where all values are computed from Figures (a) and (b) using an iterative procedure, according to an exemplary embodiment of the present disclosure;

FIG. 2(a) is an exemplary illustration of a discrete function yᵢ=f(xᵢ), with segment yᵢ_{₀}₊ⱼ=f(xᵢ_{₀}₊ⱼ), j∈[1,8](shaded), according to an exemplary embodiment of the present disclosure;

FIGS. 2(b)-2(e) are exemplary illustrations of layers 1-4 of [symbol] _{θ} (shaded), according to an exemplary embodiment of the present disclosure;

FIGS. 2(f)-2(h) are exemplary illustrations of layers 1-3 of [symbol] _{δ}, according to an exemplary embodiment of the present disclosure;

FIG. 3(a) is an exemplary visualization of a two-dimensional function zᵢ=f(xᵢ,yᵢ), according to an exemplary embodiment of the present disclosure;

FIGS. 3(b)-3(e) are exemplary visualizations of layers 1-4 of [symbol] _{θ}, according to an exemplary embodiment of the present disclosure;

FIGS. 3(f)-3(h) are exemplary visualizations of 1-3 of [symbol] _{δ}, according to an exemplary embodiment of the present disclosure;

FIG. 4(a) is an exemplary set of graphical representations of a Bayesian Inference Procedure, according to an exemplary embodiment of the present disclosure;

FIG. 4(b) is an exemplary set of graphical representation of a Hierarchical Bayesian Model with variance, according to an exemplary embodiment of the present disclosure;

FIG. 4(c) is an exemplary set of graphical representation of Hierarchical Bayesian Model with covariance, according to an exemplary embodiment of the present disclosure;

FIG. 5 is an illustrative example—matching case (e.g., fine-scale deviations are independent and the core modeling assumption holds; observation noise is equivalent to approximately 10 trials per block), with black line shows the true latent function; colored lines show posterior means from BIP, FullHBMc, HBMc-HBMv, and PolyPyramid, according to an exemplary embodiment of the present disclosure;

FIG. 6 is an illustrative example—violating case (e.g., stronger fine-scale correlations are deliberately added to push the independence assumption; observation noise is equivalent to approximately 10 trials per block), which is a similar layout as that of FIG. 5, according to an exemplary embodiment of the present disclosure;

FIG. 7 is an illustrative example—an extreme sparsity case (observation noise increased to σ=0.28, equivalent to approximately 2 trials per block, illustrating a violating structure shown in FIG. 6, which is a similar layout as that of FIG. 5, according to an exemplary embodiment of the present disclosure;

FIG. 8 is an exemplary set of graphical representations of results from one-dimensional random Gaussian function, according to an exemplary embodiment of the present disclosure;

FIG. 9 is an exemplary set of graphical representation of estimated learning curves at the top, first, and second layers of a pyramid in accordance with certain exemplary embodiments of the present disclosure;

FIG. 10 is an exemplary set of graphical representations of results from six subjects where column 1 is true latent variables

$${θ}_{{ijk}_{1} {k}_{2}}^{truth}$$

and Columns 2 and 3 are θ_{ijb}_{ₗ₁}_{b}_{ₗ₂} at the top and first layers of a parameter pyramid according to an exemplary embodiment of the present disclosure;

FIG. 11 is an exemplary set of graphs where each row represents an average CS at each of the six FDA-designated spatial frequencies, and where column 1 represents the “truth” and columns 2 through 5 represent an average CS at each of the four layers according to an exemplary embodiment of the present disclosure;

FIG. 12 is an exemplary set of graphs showing mean estimated contrast sensitivity functions (CSFs) from the HBMc-HBMv model across 36 subjects at 24 time points, with time progressing from 1-6 (row 1), 7-12 (row 2), 13-18 (row 3), to 19-24 (row 4) according to an exemplary embodiment of the present disclosure; and

FIG. 13 is a block diagram of an exemplary embodiment of a system according to the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different exemplary aspects and exemplary embodiments of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

The exemplary systems, methods, and computer accessible medium according to the exemplary embodiments of the present disclosure provide a pyramid-based multi-resolution framework with Bayesian inference to estimate high-resolution latent variables from sparse behavioral data, addressing the limitations of aggregated data in capturing fine-grained dynamics across domains like education, perceptual learning, and clinical vision. The exemplary systems, methods, and computer accessible medium according to the exemplary embodiments of the present disclosure can construct or generate a parameter pyramid ( [symbol] _{θ}) for coarse trends and a difference pyramid ( [symbol] _{θ}) for iterative refinement, supported by formal proofs for 1D and 2D cases, and can employ three Bayesian variants—BIP, HBMv, and HBMc—where HBMc can enhance the precision via a hierarchical pooling. The exemplary systems, methods, and computer accessible medium according to the exemplary embodiments of the present disclosure can be implemented in probabilistic programming languages that support Bayesian inference (e.g., PyMC). It can avoid the computational burden of large covariance matrices, offering scalability and interpretability.

The exemplary systems, methods, and computer accessible medium according to the exemplary embodiments of the present disclosure have been proven across four examples with e.g., eight models on datasets including e.g., 36 Gaussian time series, perceptual learning from e.g., 49 subjects, 36 perimetry sets, and CSF measurements from 36 subjects at 24 time points. The HBMc-HBMv model can consistently outperform others (WAIC weight=1.0), achieving the lowest RMSE (e.g., 0.0330-0.1115) and SD (e.g., 0.0212-0.0941) across experiments, reducing errors by up to e.g., 74.1% and variability by up to e.g., 78.5% compared to BIP (WAIC weight=0.0), which can show the highest errors (e.g., RMSE: 0.1666-0.4013 in Experiment 1). Compared to wavelet analysis, the exemplary systems, methods, and computer accessible medium according to the exemplary embodiments of the present disclosure can share a multi-resolution approach but can focus on discrete behavioral inference, unlike wavelet's deterministic signal decomposition. Against Gaussian processes (GP) and sparse GPs, the exemplary systems, methods, and computer accessible medium according to the exemplary embodiments of the present disclosure can provide lower computational cost and enhanced interpretability for structured data, with potential to integrate GP at each pyramid layer. Applicable to fields like learning, healthcare, and finance, this framework can facilitate high-resolution insights into human performance, with opportunities to adopt more complex generative functions for broader impact.

### Examples Highlighting the Need for High-Resolution Latent Variables

### Exemplary Student Learning Trajectories in Mathematics Education

Understanding how students acquire mathematical skills, such as algebraic or geometry, is important for effective education design. Generative models can track proficiency as latent variables evolving over time (see, e.g., Refs. 62 and 87). Typically, scores from periodic tests are averaged over weeks or months, yielding coarse learning curves (see, e.g., Refs. 18 and 105) that can obscure short-term dynamics like rapid gains from instruction (see, e.g., Ref. 82), forgetting during breaks (see, e.g., Ref. 88), or within session shifts due to fatigue (see, e.g., Refs. 5 and 24). For example, in a middle school algebra class, weekly quizzes might show steady progress, yet miss swift mastery after a worked example (see, e.g., Ref. 98), weekend forgetting (see, e.g., Ref. 88), or relearning during review. Trial-by-trial analysis in tutoring systems uncovers “aha” moments and plateaus invisible in aggregates (see, e.g., Refs. 62 and 87), while within-day declines from cognitive issues including fatigue (see, e.g., Ref. 61) also evade coarse. A logistic model tracking daily, or per-trial proficiencies can highlight the need for high temporal resolution to refine teaching strategies.

### Exemplary Learning Curves in Perceptual Learning

Perceptual learning tracks sensitivity improvements with training (see, e.g., Ref. 32), modeled via psychometric functions with sensitivities as latent variables. Aggregated data over many trials (see, e.g., Ref. 16) can hide processes like between-session consolidation (see, e.g., Refs. 57, 73 and 99), off-line gains (see e.g., Refs. 8 and 94), forgetting (see, e.g., Refs. 9 and 72), and within-session adaptation or deterioration (see, e.g., Refs. 15 and 31). Yang et al (see, e.g., Ref. 122) found block-by-block curves unveiled long-term learning and relearning dynamics missed by session averages, emphasizing the need for high temporal resolution.

### Exemplary Visual Field Mapping (VFM)

Peripheral vision, vital for daily activities, is impaired in conditions like glaucoma (see, e.g., Refs. 13, 77 and 95), diabetic retinopathy (see, e.g., Ref. 10), geographic atrophy (see, e.g., Ref. 93), or stroke (see, e.g., Ref. 104). VFM uses perimetry to measure retinal sensitivity, modeled with psychometric functions with sensitivities at many retinal locations as latent variables (see, e.g., Ref. 119). Standard automated perimetry (SAP) tests only a few trials per location (see, e.g., Refs. 3, 28, 35 and 46), limiting precision and obscuring disease progression (see, e.g., Refs. 49, 58, 59, 65, 113 and 115). High spatial resolution can be critical for accurate clinical estimates from sparse data.

### Exemplary Contrast Sensitivity Function (CSF) in Clinical Trials

The CSF, a strong predictor of daily visual task performance (see, e.g., Refs. 11, 17, 37, 41, 53, 71, 79, 97, 106 and 114), uses psychometric functions across spatial frequencies (see, e.g., Refs. 64, 70 and 111) with multidimensional latent variable, reflecting sensitivities at multiple spatial frequencies. Diseases affect these frequencies variably (see, e.g., Refs. 1, 2, 6, 30, 39, 45, 50, 55, 66, 74, 78, 80, 89, 101, 106, 107, 108, 112, 123 and 125), necessitating high-resolution analysis in clinical trials (see, e.g., Refs. 21 and 22), while sparse, periodic data (e.g., every three months) can demand advanced methods.

### Exemplary Spatial Analysis in Marketing

Marketing can leverage spatial patterns to optimize strategies, modeling consumer preferences or retail locations as latent variables (see, e.g., Bradlow et al., 2005; Cliquet, 2006). Aggregated data, like regional sales averages, masks local variations—e.g., urban vs. rural demand (see, e.g., Yang & Allenby, 2003). High spatial resolution can reveal fine-grained consumer dynamics that can be critical for targeting and placement.

### Exemplary Temporal Analysis in Stock Markets

Stock market predictions can rely on temporal models, with latent variables like volatility evolving over time (see, e.g., Bollerslev, 1986; Fama, 1970). Daily or monthly aggregates can obscure intraday swings or rapid shifts post-events (see, e.g., Jiang, 2021). High temporal resolution can be essential to capture these dynamics for accurate forecasting.

### Exemplary Challenges and Proposed Solution

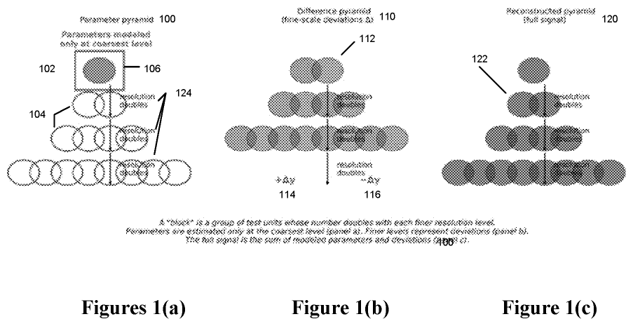

Across the examples described herein-spanning education, perception, clinical vision, spatial analysis in marketing, and temporal analysis in stock markets-a shared challenge can be estimating latent variables in generative models at high-resolution, whether in time, space, or combined domains. Higher resolution can reduce available data per estimate, complicating accuracy and precision. For instance, in perceptual learning, low-resolution learning curves uses hundreds of trials per point, while high-resolution analysis relies on just tens, amplifying estimation difficulty (see, e.g., Ref. 127). Accordingly, the exemplary systems, methods, and computer accessible medium according to the exemplary embodiments of the present disclosure can provide a multi-resolution pyramid structure paired with Bayesian inference (FIG. 1), akin to wavelet analysis in its multi-scale decomposition approach (see, e.g., Ref. 103).

As shown in FIG. 1(a), the exemplary systems, methods, and computer accessible medium according to the exemplary embodiments of the present disclosure can construct a parameter pyramid 100 having a plurality of layers. At a top layer 102 of the parameter pyramid 100, each block mean entry 104 can represent the mean of the latent variable within a corresponding block at the coarsest resolution, where the number of blocks at this coarsest level can be denoted B₀. A covariance indicator 106 (e.g., illustrated by a bounded region and a filled marker) can indicate that covariance can be modeled only at this top layer 102 of the parameter pyramid 100. The number of blocks can double with each successively finer resolution level, as indicated by resolution doubling indicators 124.

As shown in FIG. 1(b), the exemplary systems, methods, and computer accessible medium according to the exemplary embodiments of the present disclosure can construct a difference pyramid 110 that can capture fine-scale deviations between the first and second halves of each block from a previous layer. Each layer of the difference pyramid 110 can include a plurality of fine-scale deviation entries 112, where each pair of entries can represent a difference value and its negative counterpart. For example, a positive deviation value 114 (e.g., illustrated by a first marker type indicating a positive Δy) and a corresponding negative deviation value 116 (e.g., illustrated by a second marker type indicating a negative Δy) can together capture the local variation within a block from the previous layer.

As shown in FIG. 1(c), a reconstructed pyramid 120 can represent the full signal and can be obtained by iteratively combining the parameter pyramid 100 of FIG. 1(a) and the difference pyramid 110 of FIG. 1(b). Each reconstructed entry 122 in the reconstructed pyramid 120 can be computed by adding or subtracting the corresponding fine-scale deviation entries 112 from the block mean entries 104 at each successive layer. In this manner, parameters can be estimated only at the coarsest level as shown in FIG. 1(a), finer levels can represent deviations as shown in FIG. 1(b), and the full signal can be the sum of the modeled parameters and deviations as shown in FIG. 1(c). The total number of blocks B can equal the number of blocks at the coarsest level B₀ multiplied by the resolution factor, and I can equal the number of subjects.

Prior publications (see, e.g., Refs. 127, 128, 130 and 129) describe, e.g., three Bayesian methods: (1) the Bayesian Inference Procedure (BIP), estimating independent posterior distributions per subject and unit; (2) the Hierarchical Bayesian Model with variance (HBMv), jointly estimating parameters across subjects without covariance; and (3) the Hierarchical Bayesian Model with covariance (HBMc), enhancing HBMv with covariance hyperparameters for improved accuracy across subjects and tests. These hierarchical approaches can integrate population, subject, and test-level data, balancing shared information with individual differences to reduce variance and enhance precision when data is limited (see, e.g., Refs. 63, 90 and 91).

At the core of the HBMc framework of the exemplary systems, methods, and computer accessible medium according to the exemplary embodiments of the present disclosure can be its covariance structure, which enhances resolution for tasks such as learning-curve estimation and contrast sensitivity function (CSF) reconstruction. However, covariance estimation can pose major computational challenges when a large number of conditions are involved. Even in experiments with a few dozen participants, estimating large covariance matrices can become increasingly difficult and often ill-defined as the number of blocks grows-such as those with thousands of trials in perceptual learning or dense sampling in visual field mapping and CSF studies. The challenge can persist even with larger numbers of participants when the number of test blocks is high. For instance, perceptual learning experiments involving 3,500 trials (10 trials per block, B=350) can require estimation of a 350×350 covariance matrix; visual field mapping across 64 locations can involve a 64×64 matrix; and CSF datasets from clinical trials (24 visits×6 spatial frequencies) can demand a 144×144 matrix. As resolution increases, data sparsity per unit can destabilize covariance estimation and compromise model precision. This can reflect a well-documented challenge in high-dimensional generative modeling: estimating latent variables at fine temporal or spatial resolutions with limited data per estimate. (See, e.g., Refs. 132 and 133).

While techniques like sampling under conditional independence or using structured covariances (e.g., sparse or block-diagonal forms) can reduce computational demands, these may not be universal solutions. (See, e.g., Ref. 134). In high-resolution behavioral datasets, such as those with hundreds of blocks of trials or spatial samples, the curse of dimensionality can often persist, causing computational bottlenecks, unstable estimates, and overfitting risks, particularly when sample sizes are small relative to the parameter space, (See, e.g., Refs. 135 and 132). Hierarchical Bayesian models can exacerbate these issues because covariance estimation can impact inference on both fixed and random effects, and poorly chosen priors, such as inverse-Wishart, can bias estimates in high dimensions. (See, e.g., Refs. 136 and 137). Consequently, covariance matrices whose size grows as O(B²) (where B is the number of test blocks) can remain a practical bottleneck, even with approximations or shrinkage priors. (See, e.g., Refs. 138 and 139).

The pyramid-based approach of the exemplary systems, methods, and computer accessible medium according to the exemplary embodiments of the present disclosure can tackle this challenge by modeling low-resolution latent variables at the top layer using a multi-level hierarchical Bayesian model (HBM) that can incorporate covariance, then introducing deviation terms at finer resolutions constrained by the upper layers. This exemplary comprehensive model—integrating hyperparameters, top-layer parameters, deviations, and data likelihood—can be implemented within a Bayesian framework using probabilistic programming languages such as PyMC. The exemplary systems, methods, and computer accessible medium according to the exemplary embodiments of the present disclosure can be established across four exemplary scenarios, testing e.g., eight models: two baselines (BIP, HBMv) and six pyramid variants (top layers of BIP, HBMv, or HBMc; subsequent layers of BIP or HBMv). The exemplary scenarios can leverage diverse datasets to illustrate the exemplary systems, methods, and computer accessible medium according to the exemplary embodiments of the present disclosure: e.g., 36 random Gaussian time series, perceptual learning data from 49 subjects in a face-view discrimination task, 36 simulated perimetry sets for visual field mapping, and 24 contrast sensitivity function (CSF) measurements from 36 subjects.

The simulated datasets—the random Gaussian time series and the perimetry and CSF simulations—can be used to assess the framework's robustness and accuracy under controlled conditions with known ground truth, which are often unavailable in empirical studies. These simulations can complement the empirical dataset by enabling a precise evaluation of the model's capacity to capture complex patterns and generalize across diverse data structures. The description of the exemplary systems can be organized around the three central claims of the framework:
Scalability—the pyramid structure dramatically reduces computational cost compared to full-covariance hierarchical models.
Precision under sparsity—the approach reliably recovers high-resolution behavioral functions even when data are sparse (few trials per block or few subjects).
Interpretability of multi-resolution layers—the hierarchical pyramid provides complementary information across scales, enabling insight into coarse trends and fine details.

### Exemplary Pyramid Structures

### Exemplary One-Dimensional Discrete Functions

Exemplary Theorem 1. For any one-dimensional discrete function yᵢ=f(xᵢ), a multi-resolution representation in a parameter pyramid [symbol] ₆ can be derived by defining: (1) the top layer of [symbol] _{θ}, where each entry is the mean of f(xᵢ) within each block at the lowest resolution, and (2) a difference pyramid [symbol] _{δ}, capturing differences between the first and second halves of each block across resolutions.

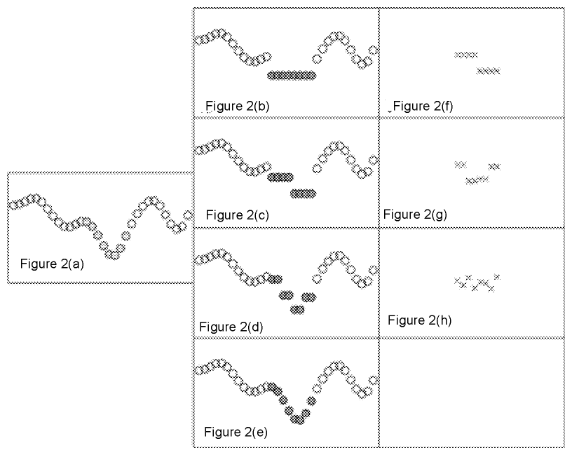

As shown in FIGS. 2(a)-2(h), the exemplary systems, methods, and computer accessible medium according to the exemplary embodiments of the present disclosure can illustrate the construction of a parameter pyramid and a difference pyramid for a one-dimensional discrete function. FIG. 2(a) can depict a discrete function represented by a series of connected markers, with a segment of eight consecutive points highlighted to indicate the range where j is an element of the interval from 1 to 8. FIGS. 2(b)-2(e) can depict layers 1 through 4 of the parameter pyramid, where each successive layer can represent progressively finer resolution averages of the original function values. At the coarsest layer (see FIG. 2(b)), a single mean value can represent the entire segment, while at the finest layer (see FIG. 2(e)), individual function values can be recovered. FIGS. 2(f)-2(h) can depict layers 1 through 3 of the difference pyramid, where each pair of respective markers can represent a difference value and its negative counterpart, capturing the differences between the first and second halves of each block across resolutions. The iterative relationship between the parameter pyramid and the difference pyramid can be such that the results of FIG. 2(b) and FIG. 2(f) can yield the results of FIG. 2(c), the results of FIG. 2(c) and FIG. 2(g) can yield the results of FIG. 2(d), and the results of FIG. 2(d) and FIG. 2(h) can yield the results of FIG. 2(e), demonstrating how the parameter pyramid values at finer resolutions can be computed by combining coarser layer values with their corresponding difference pyramid entries.

Exemplary Proof Consider a segment yᵢ_{₀}₊ⱼ=f(xᵢ_{₀}₊ⱼ), where i₀ is a starting point and j∈[1,8](see FIG. 2(a)). Define:
First layer of [symbol] _{θ}:

$${\overline{y}}_{1 - 8} = \frac{1}{8} {\sum }_{j = 1}^{8} {y}_{{i}_{0} + j} , \qquad ( 1 a )$$

First layer of [symbol] _{δ}:

$$Δ {y}_{1 - 4 , 5 - 8} = \frac{1}{2} ( {\overline{y}}_{1 - 4} - {\overline{y}}_{5 - 8} ) , \qquad ( 1 b )$$

Second layer of [symbol] _{δ}:

$$Δ {y}_{1 - 2 , 3 - 4} = \frac{1}{2} ( {\overline{y}}_{1 - 2} - {\overline{y}}_{3 - 4} ) , Δ {y}_{5 - 6 , 7 - 8} = \frac{1}{2} ( {\overline{y}}_{5 - 6} - {\overline{y}}_{7 - 8} ) , \qquad ( 1 c )$$

Third layer of [symbol] _{δ}:

$$Δ {y}_{1 , 2} = \frac{1}{2} ( {y}_{{i}_{0} + 1} - {y}_{{i}_{0} + 2} ) , Δ {y}_{3 , 4} = \frac{1}{2} ( {y}_{{i}_{0} + 3} - {y}_{{i}_{0} + 4} ) , \qquad ( 1 d )$$

$$Δ {y}_{5 , 6} = \frac{1}{2} ( {y}_{{i}_{0} + 5} - {y}_{{i}_{0} + 6} ) , Δ {y}_{7 , 8} = \frac{1}{2} ( {y}_{{i}_{0} + 7} - {y}_{{i}_{0} + 8} ) . \qquad ( 1 e )$$

Combining y̅₁₋₈ (see FIG. 2(b)) with Δy_{1-4,5-8}, the second layer of [symbol] _{θ} (see FIG. 2(c)) is:

$${\overline{y}}_{1 - 8} + Δ {y}_{1 - 4 , 5 - 8} = \frac{1}{4} {\sum }_{j = 1}^{4} {y}_{{i}_{0} + j} = {\overline{y}}_{1 - 4} , \qquad ( 2 a )$$

$${\overline{y}}_{1 - 8} - Δ {y}_{1 - 4 , 5 - 8} = \frac{1}{4} {\sum }_{j = 5}^{8} {y}_{{i}_{0} + j} = {\overline{y}}_{5 - 8} . \qquad ( 2 b )$$

Next, combining y̅₁₋₄ with Δy_{1-2,3-4} and y̅₅₋₈ with Δy_{5-6,7-8}, the third layer (see FIG. 2(d)) is:

$${\overline{y}}_{1 - 4} + Δ {y}_{1 - 2 , 3 - 4} = \frac{1}{2} {\sum }_{j = 1}^{2} {y}_{{i}_{0} + j} = {\overline{y}}_{1 - 2} , \qquad ( 3 a )$$

$${\overline{y}}_{1 - 4} - Δ {y}_{1 - 2 , 3 - 4} = \frac{1}{2} {\sum }_{j = 3}^{4} {y}_{{i}_{0} + j} = {\overline{y}}_{3 - 4} , \qquad ( 3 b )$$

$${\overline{y}}_{5 - 8} + Δ {y}_{5 - 6 , 7 - 8} = \frac{1}{2} {\sum }_{j = 5}^{6} {y}_{{i}_{0} + j} = {\overline{y}}_{5 - 6} , \qquad ( 3 c )$$

$${\overline{y}}_{5 - 8} - Δ {y}_{5 - 6 , 7 - 8} = \frac{1}{2} {\sum }_{j = 7}^{8} {y}_{{i}_{0} + j} = {\overline{y}}_{7 - 8} . \qquad ( 3 d )$$

Finally, combining third-layer arrangement with their respective difference (see FIG. 2(e)) recovers the original values:

y̅₁₋₂+Δy_{1,2}=yᵢ_{₀}₊₁,y̅₁₋₂−Δy_{1,2}=yᵢ_{₀}₊₂ (4a, 4b)

y̅₃₋₄+Δy_{3,4}=yᵢ_{₀}₊₃,y̅₃₋₄−Δy_{3,4}=yᵢ_{₀}₊₄ (4c, 4d)

y̅₅₋₆+Δy_{5,6}=yᵢ_{₀}₊₅,y̅₅₋₆−Δy_{5,6}=yᵢ_{₀}₊₆ (4e, 4f)

y̅₇₋₈+Δy_{7,8}=yᵢ_{₀}₊₇,y̅₇₋₈−Δy_{7,8}=yᵢ_{₀}₊₈. (4g, 4h)

This exemplary proof—demonstrated for a segment of eight points across four text use resolutions, can generalize to any segment and resolution level. Thus, estimating [symbol] _{θ} can require only the top layer and [symbol] _{δ}, a principle that can be leverages by the exemplary systems, methods, and computer accessible medium according to the exemplary embodiments of the present disclosure to develop estimation methods.

### Exemplary Two-Dimensional Discrete Functions

Exemplary Theorem 2. For any two-dimensional discrete function zᵢⱼ=f(xᵢ,yⱼ), a multi-resolution representation in [symbol] _{θ} can be derived by defining: (1) the top layer of [symbol] _{θ}, where each entry is the mean of f(xᵢ,yⱼ) within each region at the lowest resolution, and (2) a difference pyramid [symbol] _{δ}, capturing difference between upper and lower halves, and left and right quadrants within each half, across resolutions.

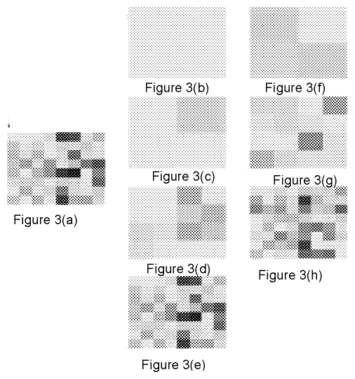

As shown in FIGS. 3(a)-3(h), the exemplary systems, methods, and computer accessible medium according to the exemplary embodiments of the present disclosure can illustrate a two-dimensional function and its multi-resolution pyramid representations. FIG. 3(a) can depict a two-dimensional function displayed as a grid with varying shading representing different function values across the spatial domain. FIGS. 3(b)-3(e) can depict layers 1 through 4 of the parameter pyramid, where FIG. 3(b) can display a uniform shading at the coarsest resolution, FIG. 3(c) can show a 2×2 grid with differentiated regions, FIG. 3(d) can present a 4×4 grid with additional variation, and FIG. 3(e) can display the finest resolution as a grid with multiple distinct values representing the most detailed parameter estimates. FIGS. 3(f)-3(h) illustrate layers 1 through 3 of the difference pyramid, where FIG. 3(f) shows a pattern at the coarsest level capturing differences between upper and lower halves, FIG. 3(g) shows a finer grid capturing differences within quadrants, and FIG. 3(h) presents the finest difference layer representing local differences between adjacent blocks.

The iterative relationship between the parameter pyramid and the difference pyramid can be such that the exemplary results shown FIGS. 3(b) and 3(f) can yield the results of FIG. 3(c), the results of FIGS. 3(c) and 3(g) can yield the results of FIG. 3(d), and the results of FIGS. 3(d) and 3(h) can yield the results of FIG. 3(e), demonstrating how the two-dimensional parameter pyramid values at finer resolutions can be computed by combining coarser layer values with their corresponding difference pyramid entries.

Exemplary Proof Consider zᵢⱼ=f(xᵢ,yᵢ) (see FIG. 3(a)), focusing on a second layer region with values z₁₁, z₁₂, z₂₁, and z₂₂ (see FIG. 3(c)). Given:
Top layer mean (see FIG. 3(b)):

$${\overline{z}}_{1 - 2 , 1 - 2} = \frac{1}{4} ( {z}_{11} + {z}_{12} + {z}_{21} + {z}_{22} ) , \qquad ( 5 a )$$

Differences (see FIG. 3(f)):

$$( 5 b )$$

$${Δ}_{1} = \frac{1}{4} ( {z}_{11} + {z}_{12} - {z}_{21} - {z}_{22} ) , {Δ}_{2} = \frac{1}{2} ( {z}_{11} - {z}_{12} ) , {Δ}_{3} = \frac{1}{2} ( {z}_{21} - {z}_{22} ) ,$$

Construct the difference function (FIG. 3f):

dz₁₁=Δ₁+Δ₂,dz₁₂=Δ₁−Δ₂, (6a, 6b)

dz₂₁=−Δ₁+Δ₃,dz₂₂=−Δ₁−Δ₃, (6c, 6d)

Recover the original values:

z̅_{1-2,1-2}+dz₁₁=z₁₁,z̅_{1-2,1-2}+dz₁₂=z₁₂ (7a, 7b)

z̅_{1-2,1-2}+dz₂₁=z₂₁,z̅_{1-2,1-2}+dz₂₂=z₂₂ (7c, 7d)

Recursively applying this process recovers zᵢⱼ at higher resolutions. Thus, estimating [symbol] _{θ} requires only its top layer and [symbol] _{δ}, which can be used by the exemplary systems, methods, and computer accessible medium according to the exemplary embodiments of the present disclosure to develop estimation methods.

### Exemplary Bayesian Inference

The exemplary systems, methods, and computer accessible medium according to the exemplary embodiments of the present disclosure can model each measurement as the outcome of a generative process [symbol] , driven by test conditions and latent variables (parameters). Here, the exemplary systems, methods, and computer accessible medium according to the exemplary embodiments of the present disclosure can employ parameter and difference pyramids, [symbol] _{θ} and [symbol] _{δ}, to estimate these latent variables within a Bayesian framework, using test conditions and measurement outcomes.

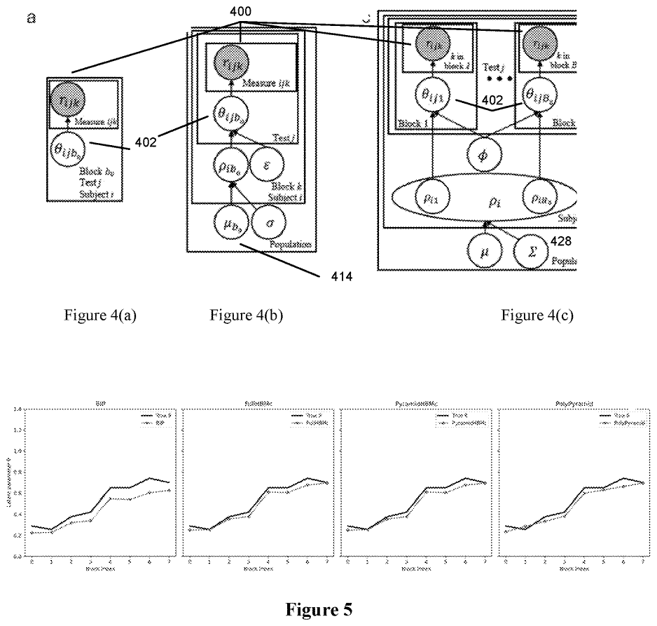

The exemplary systems, methods, and computer accessible medium according to the exemplary embodiments of the present disclosure can estimate parameters of one-dimensional (1-D) and two-dimensional (2-D) generative functions at multiple resolutions across subjects, based on e.g., four components: (1) likelihood of measurement outcomes given top layer parameter in [symbol] _{θ}, (2) likelihood for subsequent layers of [symbol] _{θ}, (3) overall likelihood across all layers of [symbol] _{θ}, and (4) posterior distribution of the parameters and hyperparameters in [symbol] _{θ} and [symbol] _{δ}, computed via Bayes' rule. Three likelihood models can be considered (see FIG. 4):
Bayesian Inference Procedure (BIP): Can assume independence of parameters across layers, subjects, and measurement blocks.
Hierarchical Bayesian Models (HBM):
   HBMc: Can incorporate between-subject covariance at the population level and within-subject covariance at the individual level.
   HBMv: Can models variance only, assuming no covariance.

As shown in FIG. 4(a), the Bayesian Inference Procedure (BIP) can include an observed measurement variable 400 that can connect to a latent parameter variable 402, where the latent parameter variable 402 can be associated with a block, test, and subject hierarchy. In the BIP, the latent parameter variable 402 for each block, test, and subject can be estimated independently. As shown in FIG. 4(b), the Hierarchical Bayesian Model with variance (HBMv) can include the observed measurement variable 400 connecting to the latent parameter variable 402, which in turn can connect to a subject-level parameter variable and an error term. A population-level mean parameter 414 and a population-level standard deviation parameter can be provided at the base of the hierarchy, and the structure can encompass test, block, and subject levels. As shown in FIG. 4(c), the Hierarchical Bayesian Model with covariance (HBMc) can include multiple observed measurement variables 400 from different blocks connecting to their respective latent parameter variables 402 for block 1 through block B₀, which can be linked through a covariance matrix parameter 428. Subject-level parameters for each block can connect to the population-level mean parameter 414 and the covariance matrix parameter 428, with the structure organized across test, subject, and population levels. The covariance matrix parameter 428 in FIG. 4(c) can distinguish HBMc from HBMv by capturing between-block dependencies at the population level, which can enhance precision when estimating latent variables across multiple measurement blocks.

### Exemplary Estimating One-Dimensional Pyramids

Consider K measurement outcomes per subject i∈[1,I] across J repeated tests, denoted rᵢⱼₖ, under condition ξᵢⱼₖ, where j∈[1,J] indexes tests k∈[1,K] indexes measurements. Assume that K is divisible by 2^{L}B₀, where L is number of additional layers in [symbol] _{θ}, and B₀ is the number of top-layer blocks. The likelihood of outcome rᵢⱼₖ follows a known generative function [symbol] :

p(rᵢⱼₖ|θᵢⱼₖ,ξᵢⱼₖ)= [symbol] (θᵢⱼₖ,ξᵢⱼₖ). (8)

Likelihood at the Top Layer of [symbol] _{θ}: The top layer has of B₀ blocks, each with s₀=K/B₀ measurements. For subject i, test j, and block b₀∈[1, B₀], measurements share a parameter θ_{ijb}_{₀} yielding:

p(rᵢⱼₖ|θ_{ijb}_{₀},ξᵢⱼₖ)=Π_{k∈b}_{₀} [symbol] (θ_{ijb}_{₀},ξᵢⱼₖ). (9)
BIP: Parameters θ_{ijb}_{₀}, can be independent across subjects, tests, and blocks. The likelihood for all outcomes is:

$$( 10 a )$$

$${ℒ}_{0}^{BIP} ( {r}_{1 : I , 1 : J , 1 : K} \vert {θ}_{1 : I , 1 : J , 1 : {B}_{0}} , {ξ}_{1 : I , 1 : J , 1 : K} ) = {\prod }_{i = 1}^{I} {\prod }_{j = 1}^{J} {\prod }_{{b}_{0} = 1}^{{B}_{0}} {\prod }_{k ϵ {b}_{0}} g ( {θ}_{{ijb}_{0}} , {ξ}_{ijk} ) ,$$

$$with prior :$$

$${p}_{0 , 0}^{BIP} ( {θ}_{1 : I , 1 : J , 1 : {B}_{0}} ) = {\prod }_{i = 1}^{I} {\prod }_{j = 1}^{J} {\prod }_{{b}_{0} = 1}^{{B}_{0}} {p}_{0} ( {θ}_{{ijb}_{0}} ) . \qquad ( 10 b )$$

HBMc: Can models hierarchical dependencies with covariance. At the population level, hyperparameter η follows:

p(η)= [symbol] (η,y,Σ)p(μ)p(Σ). (11)
1) At the individual level, hyperparameter τᵢ:

p(τᵢ|η)=p(ρᵢ|η) [symbol] (τᵢ,ρᵢ,φ)p(φ), (12)
At the test level, p(θᵢⱼ|τᵢ) is conditioned on τᵢ. The likelihood is:

$$( 13 a )$$

$${ℒ}_{0}^{H B {M}_{c}} ( {r}_{1 : I , 1 : J , 1 : K} \vert {θ}_{1 : I , 1 : J , 1 : {B}_{0}} , {ρ}_{1 : I} , μ , \sum , ϕ , {ξ}_{1 : I , 1 : j , 1 : K} ) = {\prod }_{i = 1}^{I} {\prod }_{j = 1}^{J} {\prod }_{{b}_{0} = 1}^{{B}_{0}} {\prod }_{k ϵ {b}_{0}} g ( {θ}_{{ijb}_{0}} , {ξ}_{ijk} ) p ( {θ}_{{ijb}_{0}} \vert {τ}_{i} ) 𝒩 ( {τ}_{1} , {ρ}_{i} , ϕ ) p ( ϕ ) p ( {ρ}_{i} \vert η ) 𝒩 ( η , μ , \sum ) p ( μ ) p ( \sum ) ,$$

$$with prior :$$

$${p}_{0 , 0}^{HBMc} ( μ , \sum , ϕ ) = {p}_{0} ( μ ) {p}_{0} ( \sum ) {p}_{0} ( ϕ ) . \qquad ( 13 b )$$

HBMv: Can replace covariances with variances. At the population level, for block b₀:

p(η_{b}_{₀})= [symbol] (η_{b}_{₀},μ_{b}_{₀},σ)p(μ_{b}_{₀})p(σ). (14)

At the individual level:

p(τ_{ib}_{₀}|η_{b}_{₀})= [symbol] (τ_{ib}_{₀},ρ_{ib}_{₀},ε)p(ρ_{ib}_{₀}|η_{b}_{₀})p(ε), (15)

The likelihood is:

$$( 16 a )$$

$${ℒ}_{0}^{H B {M}_{v}} ( {r}_{1 : I , 1 : J , 1 : K} \vert {θ}_{1 : I , 1 : J , 1 : {B}_{0}} , {ρ}_{1 : I , 1 : {B}_{0}} , {μ}_{1 : {B}_{0}} , σ , ε , {ξ}_{1 : I , 1 : j , 1 : K} ) = {\prod }_{i = 1}^{I} {\prod }_{j = 1}^{J} {\prod }_{{b}_{0} = 1}^{{B}_{0}} {\prod }_{k ϵ {b}_{0}} g ( {θ}_{{ijb}_{0}} , {ξ}_{ijk} ) p ( {θ}_{{ijb}_{0}} \vert {τ}_{{ib}_{0}} ) 𝒩 ( {τ}_{{ib}_{0}} , {ρ}_{{ib}_{0}} , ε ) p ( ε ) 𝒩 ( {η}_{{b}_{0}} , {μ}_{{b}_{0}} , σ ) p ( {u}_{{b}_{0}} ) p ( σ ) ,$$

$$with the prior :$$

$${p}_{0 , 0}^{HBMv} ( {μ}_{1 : {B}_{0}} , σ , ε ) = {\prod }_{{b}_{0} = 1}^{{B}_{0}} {p}_{0} ( {μ}_{{b}_{0}} ) {p}_{0} ( σ ) {p}_{0} ( ε ) . \qquad ( 16 b )$$

Likelihood at Subsequent Lavers of [symbol] _{θ}: Layer l>0 has 2^{l}B₀ blocks, each with sₗ=K/2^{l}B₀ measurements. Parameter θᵢⱼ_{_{b}}ₗ for bₗ∈[1, 2^{l}B₀] is:

$${θ}_{{ijb}_{l}} = \{ \begin{matrix}{θ}_{{ijb}_{l - 1}} + δ {θ}_{{ijb}_{l - 1}} , if {b}_{l} = 2 {b}_{l - 1} - 1 \\ {θ}_{{ijb}_{l - 1}} - δ {θ}_{{ijb}_{l - 1}} , if {b}_{l} = 2 {b}_{l - 1}\end{matrix} . \qquad ( 17 )$$

The likelihood is:

p(rᵢⱼₖ|θ_{ijb}_{ₗ},ξᵢⱼₖ)=Π_{k∈b}_{₀} [symbol] (θ_{ijb}_{ₗ},ξᵢⱼₖ). (18)
BIP: Assumes δθ_{1:I,1:J,B}_{ₗ₋₁} independence, with likelihood:

$$( 19 a )$$

$${ℒ}_{l}^{BIP} ( {r}_{1 : I , 1 : J , 1 : K} \vert {δθ}_{1 : I , 1 : J , 1 : {B}_{l - 1}} , {ξ}_{1 : I , 1 : j , 1 : K} ) = {\prod }_{i = 1}^{I} {\prod }_{j = 1}^{J} {\prod }_{{b}_{l - 1} = 1}^{{B}_{L - 1}} {\prod }_{k ϵ {b}_{l}} g ( {θ}_{{ijb}_{l}} , {ξ}_{ijk} ) ,$$

$$and prior :$$

$${p}_{0 , l}^{BIP} ( {δθ}_{1 : I , 1 : J , 1 : {B}_{l - 1}} ) = {\prod }_{i = 1}^{I} {\prod }_{j = 1}^{J} {\prod }_{{b}_{l - 1} = 1}^{{B}_{l - 1}} {p}_{0} ( δ {θ}_{{ijb}_{l - 1}} ) . \qquad ( 19 b )$$

HBMv: Models δθ_{ijb}_{ₗ₋₁} hierarchically. At the population level:

p(δη_{b}_{ₗ₋₁})= [symbol] (δη_{b}_{ₗ₋₁},δμ_{b}_{ₗ₋₁},δσ_{b}_{ₗ₋₁})p(μ_{b}_{_{b-1}})p(δσ_{b}_{ₗ₋₁}). (20)

At the individual level:

p(δτ_{ib}_{ₗ₋₁}|δη_{b}_{ₗ₋₁})= [symbol] (δτ_{ib}_{ₗ₋₁},δρ_{ib}_{ₗ₋₁},δε_{b}_{ₗ₋₁})p(δρ_{ib}_{ₗ₋₁}|δη_{b}_{ₗ₋₁})p(δε_{b}_{ₗ₋₁}). (21)

The likelihood is:

$$( 22 a )$$

$${ℒ}_{l}^{BIP} ( {r}_{1 : I , 1 : J , 1 : K} \vert {δθ}_{1 : I , 1 : J , 1 : {B}_{l - 1}} , δ {ρ}_{1 : I , 1 : {B}_{l - 1}} , δ {μ}_{1 : {B}_{l - 1}} , δ {σ}_{{b}_{1 - 1}} , δ {ε}_{{b}_{l - 1}} , {ξ}_{1 : I , 1 : J , 1 : K} ) = {{\prod }_{i = 1}}^{I} {{\prod }_{j = 1}}^{J} {\prod }_{{b}_{l - 1} = 1}^{{B}_{l - 1}} {\prod }_{k ϵ {b}_{l}} g ( {θ}_{{ijb}_{l}} , {ξ}_{ijk} ) p ( {δθ}_{{ijb}_{l - 1}} \vert δ {τ}_{{ib}_{l - 1}} ) 𝒩 ( δ {τ}_{{ib}_{l - 1}} , δ {ρ}_{{ib}_{l - 1}} , δ {ε}_{{b}_{l - 1}} ) p ( δ {ρ}_{{ib}_{l - 1}} \vert δ {η}_{{b}_{l - 1}} ) p ( δ {ε}_{{b}_{l - 1}} ) 𝒩 ( δ {η}_{{b}_{l - 1}} , δ {μ}_{{b}_{l - 1}} , δ {σ}_{{b}_{l - 1}} ) p ( {μ}_{{b}_{b - 1}} ) p ( δ {σ}_{{b}_{l - 1}} )$$

$$and prior :$$

$$( 22 b )$$

$${p}_{0 , l}^{HBMv} ( δ {μ}_{1 : {B}_{l - 1}} , δ {σ}_{{b}_{l - 1}} , δ {ε}_{{b}_{l - 1}} ) = {\prod }_{{b}_{l - 1} = 1}^{{B}_{l - 1}} {p}_{0} ( δ {μ}_{{b}_{l - 1}} ) {p}_{0} ( δ {σ}_{{b}_{l - 1}} ) {p}_{0} ( δ {ε}_{{b}_{l - 1}} ) .$$

Overall Likelihood: The total likelihood across all layers is:

$$ℒ = {\prod }_{l = 0}^{L} {ℒ}_{l} . \qquad ( 23 )$$

$$where {ℒ}_{0} is {ℒ}_{0}^{BIP} , {ℒ}_{0}^{HBMv} , or {ℒ}_{0}^{HBMc} , and {ℒ}_{l} ( for l > 0 ) is {ℒ}_{l}^{BIP}$$

$$or {ℒ}_{l}^{HBMv} .$$

Posterior Computation: The joint posterior distribution of all the parameters and hyperparameters across all layers of [symbol] _{θ} and [symbol] _{δ} using Bayes' rule:

$$p ( X \vert {r}_{1 : I , 1 : J , 1 : K} , , {ξ}_{1 : I , 1 : J , 1 : K} ) = \frac{ℒ {p}_{0} ( Ω )}{\int ℒ {p}_{0} ( Γ ) d Ω} , \qquad ( 24 )$$

$$and prior :$$

$${p}_{0} ( Ω ) = {\prod }_{l = 0}^{L} {p}_{0 , l} , \qquad ( 25 )$$

where X=[Xₗ, l∈[0,L]] includes all parameters and hyperparameters, and Ω denotes BIP parameters and HBM hyperparameters.

### Exemplary Estimating Two-Dimensional Pyramids

In the exemplary systems, methods, and computer accessible medium according to the exemplary embodiments of the present disclosure, the estimation of two-dimensional pyramids Soo can follow a procedure similar to the one-dimensional case, with key differences outlined below.

Exemplary measurements can occur or be made in a two-dimensional space, with K₁ measurements along the first dimension and K₂ measurements along the second for each subject i∈[1,I] across J tests. Outcomes are denoted rᵢⱼₖ_{₁}_{,k}_{₂}, and the test conditions are ξᵢⱼₖ_{₁}_{,k}_{₂}, where j∈[1,J] indexes tests, and k₁∈[1,K₁] and k₂∈[1,K₂] index measurements in each dimension. The exemplary systems, methods, and computer accessible medium according to the exemplary embodiments of the present disclosure can assume K₁ is divisible by 2^{L}B₀₁ and K₂ by 2^{L}B₀₂, where L is the number of additional layers in [symbol] _{θ}, and B₀₁ and B₀₂ are the number of blocks at the top layer in the first and second dimensions, respectively.

The likelihood of outcome rᵢⱼₖ_{₁}_{,k}_{₂} for subject i, test j, and measurement (k₁, k₂) can be governed by a generative function [symbol] , depending on latent variable θᵢⱼₖ_{₁}_{,k}_{₂} and condition ξᵢⱼₖ_{₁}_{,k}_{₂}:

p(rᵢⱼₖ_{₁}_{,k}_{₂}|θᵢⱼₖ_{₁}_{,k}_{₂},ξᵢⱼₖ_{₁}_{,k}_{₂})= [symbol] (θᵢⱼₖ_{₁}_{,k}_{₂},ξᵢⱼₖ_{₁}_{,k}_{₂}). (26)

At the top layer of [symbol] _{θ}, the exemplary systems, methods, and computer accessible medium according to the exemplary embodiments of the present disclosure can specify the likelihood of all K₁K₂ outcomes across I subjects and J tests using either BIP, HBMv, or HBMc, with parameters θ_{ijb}_{₀₁}_{,b}_{₀₂} (where b₀₁∈[1,B₀₁] and b₀₂∈[1,B₀₂]). HBMv and HBMc include additional hyperparameters, as in the 1D case.

For layers l>0, parameters θ_{ijb}_{ₗ₁}_{,b}_{ₗ₂} can be derived from the previous layer's θ_{ijb}_{_{l-1,1}}_{,b}_{_{l-1,2}} and three differences from

$${𝓅}_{δ} : {δθ}_{{ijb}_{l - 1 , 1} , {b}_{l - 1 , 2}}^{1} , {δθ}_{{ijb}_{l - 1 , 1} , {b}_{l - 1 , 2}}^{2} , and {δθ}_{{ijb}_{l - 1 , 1} , {b}_{l - 1 , 2}}^{3} .$$

The update rule is:

$$( 27 )$$

$${θ}_{{ijb}_{l 1} {b}_{l 2}} = \{ \begin{matrix}\begin{matrix}{θ}_{{ijb}_{l - 1 , 1} {b}_{l - 1 , 2}} + δ {θ}_{{ijb}_{l - 1 , 1} {b}_{l - 1 , 2}}^{1} + δ {θ}_{{ijb}_{l - 1 , 1} {b}_{l - 1 , 2}}^{2} , if {b}_{l 1} = \\ 2 {b}_{l - 1 , 1} - 1 , {b}_{l 2} = 2 {b}_{l - 1 , 2} - 1\end{matrix} \\ \begin{matrix}{θ}_{{ijb}_{l - 1 , 1} {b}_{l - 1 , 2}} + δ {θ}_{{ijb}_{l - 1 , 1} {b}_{l - 1 , 2}}^{1} - δ {θ}_{{ijb}_{l - 1 , 1} {b}_{l - 1 , 2}}^{2} , if {b}_{l 1} = \\ 2 {b}_{l - 1 , 1} - 1 , {b}_{l 2} = 2 {b}_{l - 1 , 2}\end{matrix} \\ \begin{matrix}{θ}_{{ijb}_{l - 1 , 1} {b}_{l - 1 , 2}} + δ {θ}_{{ijb}_{l - 1 , 1} {b}_{l - 1 , 2}}^{1} + δ {θ}_{{ijb}_{l - 1 , 1} {b}_{l - 1 , 2}}^{3} , if {b}_{l 1} = \\ 2 {b}_{l - 1 , 1} , {b}_{l 2} = 2 {b}_{l - 1 , 2} - 1\end{matrix} \\ \begin{matrix}{θ}_{{ijb}_{l - 1 , 1} {b}_{l - 1 , 2}} + δ {θ}_{{ijb}_{l - 1 , 1} {b}_{l - 1 , 2}}^{1} - δ {θ}_{{ijb}_{l - 1 , 1} {b}_{l - 1 , 2}}^{3} , if {b}_{l 1} = \\ 2 {b}_{l - 1 , 1} , {b}_{l 2} = 2 {b}_{l - 1 , 2}\end{matrix}\end{matrix} .$$

Likelihoods for each layer l are specified using BIP or HBMv, mirroring the 1D approach. The overall likelihood across all layers of [symbol] _{θ} is the product of layer-specific likelihoods, and posterior distributions of parameters and hyperparameters in [symbol] _{θ} and [symbol] _{δ} are computed using Bayes' rule (Eq. 25).

### EXEMPLARY TESTS

### Illustrative Example

To make the pyramid concept concrete and assumptions explicit, consider a minimal toy problem with only 8 test blocks (B=8 is the total number of blocks; B₀=2 is the number of blocks at the top/coarsest layer, each covering 4 fine blocks; I=number of subjects; see Table 2) measured on 20 subjects. The true latent function is a smooth coarse trend plus small noise. Four models can be compared: (1) BIP (independent parameters), (2) FullHBMc (full 8×8covariance), (3) HBMc-HBMv, and (4) PolyPyramid (alternative polynomial reparameterization using 0th- and 1st-order Legendre polynomials per coarse block, also with covariance only at the top layer). The Python script for this illustrative example (including all four models and the three cases) is publicly available at https://github.com/zll2001-nyu/pyramidHBM. Three cases can be considered:

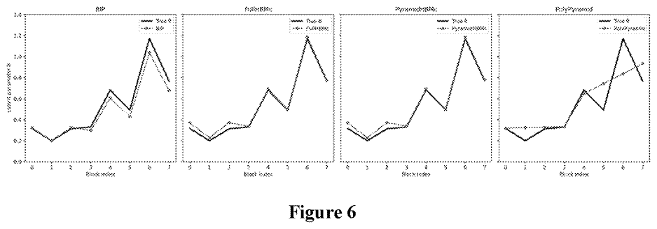

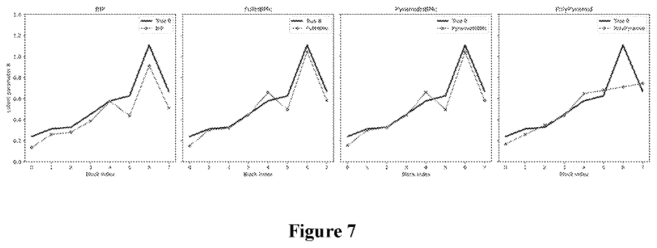

Matching case (fine-scale deviations are independent, core assumption holds; observation noise equivalent to approximately 10 trials per block) is shown in FIG. 5.

Violating case (stronger fine-scale correlations are deliberately added, assumption is pushed; observation noise equivalent to approximately 10 trials per block) is shown in FIG. 6.

Extreme sparsity case (stronger fine-scale correlations are deliberately added, assumption is pushed; observation noise increased to σ=0.28, equivalent to approximately 2 trials per block) is shown in FIG. 7.

The three cases can be constructed as follows. In the matching case, fine-scale deviations around the coarse trend are drawn independently from a small Gaussian noise. In the violating case, a strong sinusoidal oscillation (amplitude 0.25) can be added plus a shared correlation component to deliberately introduce fine-scale structure that can violate the independence assumption. The extreme sparsity case can use the same violating structure but can increase the observation noise from σ=0.10 to σ=0.28, simulating the effect of having only about 2 trials per block instead of 10. This can allow direct comparison of model robustness as data become sparser.

Performance is summarized in Table 1 using root-mean-square error (RMSE), the primary metric for how accurately each model recovers the true latent function (lower is better). HBMc-HBMv can achieve the lowest (or tied-lowest) RMSE across all three cases while using a dramatically smaller covariance matrix (only a 2×2 matrix at the top layer) compared with FullHBMc. In the matching case, HBMc-HBMv and FullHBMc can perform almost identically. In the violating case, HBMc-HBMv can remain stable and can clearly outperform both BIP and the polynomial alternative. In the extreme-sparsity case, HBMc-HBMv can again match or exceed FullHBMc while BIP can show substantially larger error. These results illustrate the three core claims of the framework: scalability (far smaller covariance), precision under sparsity (robust recovery even with ~2 trials per block), and interpretability (explicit separation of coarse trends from fine-scale deviations). This table is shown to compare model recovery accuracy; HBMc-HBMv consistently achieves the lowest (or tied-lowest) RMSE while using far less computation than FullHBMc.

TABLE 1
Exemplary RMSE across the three illustrative
cases (lower is better).

| Case | BIP | FullHBMc | HBMc-HBMv | PolyPyramid |
|---|---|---|---|---|
| Matching | 0.090 | 0.039 | 0.038 | 0.045 |
| Violating | 0.068 | 0.030 | 0.031 | 0.165 |
| Extreme sparse | 0.123 | 0.074 | 0.074 | 0.150 |

As shown in FIG. 5, the exemplary systems, methods, and computer accessible medium according to the exemplary embodiments of the present disclosure can illustrate the matching case of the illustrative example, where fine-scale deviations can be independent and the core modeling assumption can hold, with observation noise equivalent to approximately 10 trials per block. FIG. 5 can comprise four panels arranged horizontally, each corresponding to a different model: BIP, FullHBMc, PyramidHBMc (i.e., HBMc-HBMv), and PolyPyramid. Each panel can display a graph with the x-axis representing Block Index and the y-axis representing the latent parameter θ. Within each panel, a first line can show the true latent function, while a second line can show the posterior mean from the respective model. Across all four panels, the true latent function can exhibit a generally increasing trend with some local variations, and the posterior mean lines in each panel can track the true latent function with varying degrees of accuracy, demonstrating how each of the four models can recover the underlying latent variables from the observed data under conditions where the modeling assumptions can be satisfied.

As shown in FIG. 6, the exemplary systems, methods, and computer accessible medium according to the exemplary embodiments of the present disclosure can illustrate the violating case of the illustrative example, where stronger fine-scale correlations can be deliberately added to push the independence assumption, with observation noise equivalent to approximately 10 trials per block. FIG. 6 can follow the same layout as FIG. 5, comprising four panels arranged horizontally, each corresponding to a different model: BIP, FullHBMc, PyramidHBMc (i.e., HBMc-HBMv), and PolyPyramid. Each panel can display a graph with the x-axis representing Block Index and the y-axis representing the latent parameter θ. Within each panel, a first line can show the true latent function, while a second line can show the posterior mean from the respective model. The true latent function can exhibit a non-monotonic pattern with peaks and valleys across the block indices, and each model's posterior mean can attempt to track this underlying function with varying degrees of accuracy. In this violating case, HBMc-HBMv can remain stable and can clearly outperform both BIP and the polynomial alternative, demonstrating the robustness of the pyramid framework even when the core modeling assumption of independence can be violated.

As shown in FIG. 7, the exemplary systems, methods, and computer accessible medium according to the exemplary embodiments of the present disclosure can illustrate the extreme sparsity case of the illustrative example, where observation noise can be increased to σ=0.28, equivalent to approximately 2 trials per block, with the same violating structure as FIG. 6. FIG. 7 can follow the same layout as FIG. 5, comprising four panels arranged horizontally, each corresponding to a different model: BIP, FullHBMc, PyramidHBMc (i.e., HBMc-HBMv), and PolyPyramid. Each panel can display a graph with the x-axis representing Block Index and the y-axis representing the latent parameter θ. Within each panel, a first line can show the true latent function, while a second line can show the posterior mean from the respective model. The true latent function can exhibit a characteristic pattern with a peak and decline across the block indices, and the posterior mean estimates from each model can attempt to track the true latent function with varying degrees of accuracy under conditions of extreme data sparsity. In this extreme sparsity case, HBMc-HBMv can again match or exceed the accuracy of FullHBMc while BIP can show substantially larger error, demonstrating the robustness of the pyramid framework even when data can be severely limited.

All models share the same weakly informative population-level mean prior (Normal(0, 1)) and exponential priors on standard deviations to encourage appropriate shrinkage. FullHBMc uses a full covariance matrix across all blocks and serves as the most general model. HBMc-HBMv achieves comparable or superior performance while being much more computationally efficient and showing excellent convergence stability, thanks to restricting covariance estimation to only the top layer (a 2×2 matrix). The PolyPyramid model uses a rigid low-order Legendre polynomial basis (constant+linear term) within each coarse block; this removes the power-of-two block-size restriction but cannot flexibly capture local fine-scale oscillations or random deviations, leading to substantially higher RMSE in the violating and extreme-sparsity cases.

The exemplary systems, methods, and computer accessible medium according to the exemplary embodiments of the present disclosure can directly demonstrate how the pyramid framework recovers multi-dimensional behavioral functions from sparse data, with the three core claims (scalability, precision under sparsity, interpretability) visible across the figures and tables. All subsequent Results sections are organized around these claims, with direct mapping to the figures and tables.

### Exemplary Core Modeling Assumptions and Justification

The pyramid framework consists of a top-layer parameter pyramid that models coarse-scale block means with a covariance structure, and successive layers of a difference pyramid that introduce fine-scale deviations constrained by the upper-layer estimates. Covariance is modeled only at the coarsest level of the parameter pyramid.

The pyramid approach is valid under the assumption that the dominant correlations among the latent parameters occur at coarse scales (captured by the top-layer block means) while fine-scale deviations (Δy) are approximately independent or only locally correlated. This assumption is justified by the smoothness and gradual nature of most behavioral functions (e.g., contrast sensitivity functions, perceptual learning curves, and visual field maps), and it mirrors the multi-resolution principles underlying wavelet analysis and splines.

When this assumption is violated (e.g., by strong local correlations at every scale), the model may slightly underestimate fine-scale covariance. However, the illustrative example and sparsity simulations across all four studies demonstrate that Pyramid-HBMc remains stable and provides better generalization. In contrast, FullHBMc, which attempts to estimate full covariance across all blocks, tends to overfit noise under data sparsity, leading to poorer WAIC and less reliable estimates. Thus, restricting covariance to the coarsest level not only dramatically reduces computational cost but also acts as beneficial regularization in realistic high-resolution behavioral datasets.

### Exemplary General Methods

The exemplary systems, methods, and computer accessible medium according to the exemplary embodiments of the present disclosure can evaluate eight models for estimating latent variables in one-dimensional (1D) and two-dimensional (2D) measurements, as well as multi-dimensional latent variables at each time point, using simulated and real data in four tests. These can include e.g., six pyramid-based models and two models that can directly estimate latent variables across multiple resolutions.

The exemplary systems, methods, and computer accessible medium according to the exemplary embodiments of the present disclosure can validate eight models for estimating behavioral functions in one-dimensional (1D) and two-dimensional (2D) measurements, as well as multi-dimensional behavioral functions at each time point, using four simulated and real datasets with B blocks and I subjects. Here denotes the population-level mean parameter, σ the standard deviation, and ρ (or Σ) the correlation or covariance matrix (estimated only at the top layer in HBMc-HBMv; see Table 2 for a full glossary of parameters and indices).

TABLE 2
Exemplary Glossary of Parameters and Indices.

| Symbol/ | |
|---|---|
| Index | Description |
| B | Total number of fine-resolution blocks (test units) |
| B₀ | Number of blocks at the top (coarsest) layer |
| I | Number of subjects |
| J | Number of repeated tests per subject (in some studies) |
| L | Pyramid layer index (L = 0 is the top/coarse layer) |
| θ | Subject-level latent parameter of interest |
| | (e.g., log-threshold, sensitivity) |
| Δy | Difference parameters in the difference pyramid |
| μ | Population-level mean parameter |
| σ | Standard deviation (subject-level or population-level) |
| ρ or Σ | Correlation or covariance matrix |
| | (estimated only at the top layer in Pyramid-HBMc) |
| δ | Fine-scale deviation parameters |
| | (modeled with variance only in lower layers) |
| γ | Guessing rate in the Weibull psychometric function |
| η | Lapse rate in the Weibull psychometric function |
| θ | Threshold parameter in the Weibull psychometric function |
| κ | Slope parameter in the Weibull psychometric function |

The models consisted of two baselines (BIP and HBMv) and six pyramid variants. In the pyramid models, the top layer of the parameter pyramid used either BIP, HBMv, or HBMc, while the subsequent layers of the difference pyramid used either BIP or HBMv. This yielded six combinations: BIP-BIP, BIP-HBMv, HBMv-BIP, HBMv-HBMv, HBMc-BIP, and HBMc-HBMv. The first term denotes the specification used for the top (coarsest) layer, and the second denotes the specification used for the lower (finer) layers. The two baseline models (BIP and HBMv) estimated latent variables directly across all resolutions without the pyramid structure.

The eight model variants were chosen to systematically test two central hypotheses: (1) the value of hierarchical pooling at the top (coarsest) layer (BIP vs. HBMv vs. HBMc), and (2) the refinement strategy in the lower (finer) layers (BIP vs. HBMv). BIP serves as the standard independent-parameter baseline used in most psychophysical studies. FullHBMc represents the previous state-of-the-art hierarchical model with full covariance across all layers (as developed in prior work), but was not computed in the four main datasets because the covariance matrix becomes ill-defined or computationally intractable at the finest scales with sparse data. The six pyramid variants (BIP-BIP, BIP-HBMv, HBMv-BIP, HBMv-HBMv, HBMc-BIP, and HBMc-HBMv) test whether restricting covariance modeling to the coarsest layer preserves accuracy while dramatically improving scalability.

The four datasets were selected to span the full intended scope of multi-dimensional behavioral functions: 1D temporal (Gaussian time series and perceptual learning curves), 2D spatial (visual field perimetry), and longitudinal multi-dimensional (contrast sensitivity functions across 24 time points). These datasets allow direct assessment of scalability, precision under sparsity, and interpretability of multi-resolution layers, while enabling explicit comparison to the established BIP approach and the previous state-of-the-art FullHBMc model.

For 1D and 2D simulations, the exemplary systems, methods, and computer accessible medium according to the exemplary embodiments of the present disclosure can generate true latent variable values and can apply staircase procedures to produce measurement outcomes. For multi-dimensional CSF simulations, the exemplary systems, methods, and computer accessible medium according to the exemplary embodiments of the present disclosure can use the qCSF procedure to generate time-varying measurement outcomes. Real data can be used from e.g., 49 subjects performing a face-view discrimination task over e.g., 3,500 trials, with face orientations determined by a staircase method (see, e.g., Ref. 120).

Most or all analyses can be conducted on a computer and simulated datasets can be generated using e.g., MATLAB 2022b (MathWorks, 2022). Bayesian estimation can be performed in e.g., PyMC 5.10.0 with Python 3.11, employing variational inference with obj_n_m=3 to sample posterior distributions. Each model can undergo e.g., 200,000 inference steps, from which e.g., 5,000 posterior samples can be drawn. Model comparisons can utilize e.g., the Watanabe-Akaike Information Criterion (WAIC) (see, e.g., Refs. 40, 109), which can be computed using likelihoods at the highest resolution. Posterior samples can be subsequently analyzed in e.g., MATLAB to evaluate the accuracy and precision of the estimated parameters.

### Exemplary Test 1. One-Dimensional Random Gaussian Function

This test simulated 960 “true” latent variables (log₁₀(thresholds)) for 36 subjects (I=36) by sampling from a multivariate Gaussian distribution, An interleaved staircase (60% 3-down/1-up, 40% 2-down/1-up) generated trial-by-trial stimulus contrasts and binary responses. Although up/down staircases are generally not optimal for slope estimation, the combination of 3-down/1-up and 2-down/1-up rules generated a sufficiently broad range of contrast levels and responses across the psychometric function, which provided adequate data for the hierarchical Bayesian models to estimate both threshold and slope parameters.

Simulated Dataset: For each simulated subject i∈[1, 36], a 960-dimensional Gaussian process sample {Xᵢⱼₖ,j=1, k∈[1,960]} was generated with zero mean function and convariance kernel:

$$K ( {X}_{ijk} , {X}_{{ijk}^{′}} ) = \frac{1}{{s}_{1}^{2}} {e}^{\frac{- {( {X}_{ijk} - {X}_{{ijk}^{′}} )}^{2}}{2 {s}_{2}^{2}}} , where {s}_{1} = 10 , and {s}_{2} = 40. \qquad ( 28 )$$

These were scaled to “true” thresholds:

$${θ}_{i 1 k}^{truth} = - 0.8 * \frac{{X}_{i 1 k} - {min}_{i , t} ( {X}_{i 1 k} )}{{max}_{i , k} ( {X}_{i 1 k} ) - {min}_{i , t} ( {X}_{i 1 k} )} - 0.1 , \qquad ( 29 )$$

ranging from −0.9 to −0.1.

In a two-alternative forced-choice (2AFC) task, responses followed a Weibull psychometric function:

$$p ( {r}_{ijk} = 1 \vert {θ}_{ijk}^{truth} , {κ}^{truth} , {c}_{ijk} ) = γη + ( 1 - η ) ( γ + ( 1 - γ ) ( 1 - exp ( - {( \frac{{c}_{ijk}}{{10}^{{θ}_{ijk}^{truth} - \frac{1}{{κ}^{truth}} lo {g}_{10} ( lo g ( \frac{1 - γ}{1 - {p}_{1.5}} ) )}} )}^{{κ}^{truth}} ) ) ) , \qquad ( 30 a )$$

$$p ( {r}_{ijk} = 0 \vert {θ}_{ijk}^{truth} , {κ}^{truth} , {c}_{ijk} ) = 1 - p ( {r}_{ijk} = 1 \vert {θ}_{ijk}^{truth} , {κ}^{truth} , {c}_{ijk} ) , \qquad ( 30 b )$$

with γ=0.5 (guessing rate), η=0.04 (lapse rate), p_{1.5}=0.856 (correct response probability at d′=1.5), and κ^{truth} as the slope. Contrast cᵢⱼₖ was adjusted via staircases: 3-down/1-up (decreased by 0.9 after three correct, increased by 1.1 after incorrect) or 2-down/1-up (decreased by 0.9 after two correct, increased by 1.1 after incorrect), starting at 0.38 and 0.30, respectively.

### Model Specification:

The model of the generative function mirrored Eqs. 31a,b:

$$p ( {r}_{ijk} = 1 \vert {θ}_{ijk} , κ , {c}_{ijk} ) = γ η + ( 1 - η ) ( γ + ( 1 - γ ) ( 1 - exp ( - {( \frac{{c}_{ijk}}{1 {0}^{{θ}_{ijk} - \frac{1}{κ} lo g 10 ( l o g ( \frac{1 - γ}{1 - {p}_{1.5}} ) )}} )}^{κ} ) ) ) , \qquad ( 32 a )$$

$$p ( {r}_{ijk} = 0 \vert {θ}_{ijk} , κ , {c}_{ijk} ) = 1 - ( {r}_{ijk} = 0 \vert {θ}_{ijk} , κ , {c}_{ijk} ) . \qquad ( 32 b )$$

with θᵢⱼ_{ₖ} and κ as parameters to estimate.

A four-layer pyramid [symbol] _{θ} was defined: B₀=12, B₁=24, B₂=48, B₃=96. Priors for BIP, HBMv and HBMc models in [symbol] _{θ} and [symbol] _{δ} are detailed in Table 3. HBMc priors were set only at the top layer due to ill-defined covariance at lower layers of [symbol] _{θ} for I=36. Furthermore, in Table 3, notation: U(lb,ub) is a uniform distribution with bounds lb and ub; Γ(α,β) is a gamma distribution with shape α and rate β; U^{(B}^{₀}⁾(lb,ub) is a B₀-dimensional uniform; ε(λ,B₀) is a B₀-dimensional exponential with rate λ; LKJCov(v,sd_dist0,B₀) is a Cholesky-decomposed B₀×B₀ covariance distribution with rate v and SD sd_dist0.

TABLE 3
Exemplary Prior distributions specified for the three
main model variants (BIP, HBMv, HBMc)
in validation test 1 (Gaussian time series dataset).

| | | |
|---|---|---|
| [symbol] θ | BIP | p₀(B_{ijb}_{ₗ}) = U(lb, ub), lb = −2.0, ub = 0.5, |
| | | i ϵ [1, 36], j = 1, bₗϵ [1, Bₗ], l ϵ [0, 3] |
| | | p₀(κ) = U(lb, ub), lb = 1, ub = 3 |
| | HBMv | p₀(μ_{b}_{ₗ}) = U(lb, ub), lb = −2.0, |
| | | ub = 0.5, bₗϵ [1, B₁], l ϵ [0, 3] |
| | | p₀(σ_{b}_{ₗ}) = Γ(αₚₒₚ, βₚₒₚ), p₀(ε_{b}_{ₗ}) = Γ(α_{ind}, β_{ind}), |
| | | αₚₒₚ = 4.0, α_{ind} = 4.0, βₚₒₚ = 10, β_{ind} = 10 |
| | | p₀(κ) = U(lb, ub), lb = 1, ub = 3 |
| | HBMc | p₀(μ) = U^{(B}^{₀}⁾(lb, ub), lb = −2.0, ub = 0.5 |
| | | p₀(sd_dist0) = ε(λ₀, B₀), p₀(Σ) = |
| | | LKJCov(v₀, sd_dist0, B₀), λ₀ = 3.0, v₀ = 2.0 |
| | | p₀(ε_{b}_{₀}) = Γ(α_{ind}, β_{ind}), α_{ind} = 4.0, β_{ind} = 10 |
| | | p₀(κ) = U(lb, ub), lb = 1, ub = 3 |
| [symbol] δ | BIP | p₀(δθ_{ijb}_{ₗ}) = U(δ_{lb}_{ₗ}, δu_{lb}_{ₗ}), i ϵ |
| | | [1, 36], j = 1, bₗϵ [1, Bₗ] l ϵ [0, 2] |
| | | δ_{lb}_{ₗ} = −0.25, δubₗ = 0.25 |
| | HBMv | p₀(δμ_{b}_{ₗ}) = U(δlbₗ, δμ_{b}_{ₗ}), bₗϵ [1, Bₗ], l ϵ [0,2] |
| | | δlbₗ = −0.25, δubₗ = 0.25 |
| | | p₀(δσ_{b}_{ₗ}) = Γ(δα_{pop,l}, δβ_{pορ,l}), |
| | | p₀(δε_{b}_{ₗ}) = Γ(δα_{ind}, δβ_{ind,l}) |
| | | δα_{pop,l} = 3.0, δα_{ind,l} = 3.0, |
| | | δβ_{pop,l} = 10, δβ_{ind,l} = 10 |

Exemplary Results: The results of this exemplary validation test can demonstrate the three core claims of the framework on 1D Gaussian time-series data using B blocks and I subjects, where θ represents the subject-level latent parameter (see Table 2): (1) the pyramid structure dramatically reduces computational cost (scalability), (2) HBMc-HBMv reliably recovers the true function even under sparse sampling conditions (precision under sparsity; main analyses used a minimum of 10 trials per block, with additional simulations exploring further reductions), and (3) the multi-resolution layers provide complementary information that improves interpretability of coarse trends versus fine details.

Weights from pairwise model comparisons (WAIC weights, which can be interpreted as the relative probability that a given model is the best among those compared) are summarized in Table 4. HBMc-HBMv was the top model, winning 7/7 comparisons (weight=1.0) against all others. HBMv-HBMv was a strong second, winning 6/7 (loses only to HBMc-HBMv, weight=0.0). BIP-HBMv won 5/7, losing to HBMv-HBMv and HBMc-HBMv. HBMv-BIP and HBMc-BIP won 3/7 and 4/7 respectively, with split weights against BIP-BIP (e.g., 0.01 vs. 0.99 and 0.30 vs. 0.70). BIP-BIP won 4/7, including close contests with HBMv-BIP and HBMc-BIP. HBMv won 1/7 (only vs. BIP), and BIP lost all 7 (weight=0.0). HBMc-HBMv stood out as the best, followed by HBMv-HBMv. BIP was the weakest in test 1. In Table 4, each entry can show the WAIC weight for the row model when directly compared against the column model, where a value of 1.0 indicates the row model is overwhelmingly preferred and 0.0 indicates it is effectively ruled out.

TABLE 4
Exemplary Model Weights in Test 1.

| | | | BIP- | | | | | |
|---|---|---|---|---|---|---|---|---|
| Model | BIP | HBMv | BIP | BIP-HBMv | HBMv-BIP | HBMv-HBMv | HBMc-BIP | HBMc-HBMv |
| BIP | — | 0.0 | 0.0 | 0.0 | 0.0 | 0.0 | 0.0 | 0.0 |
| HBMv | 1.0 | — | 0.0 | 0.0 | 0.0 | 0.0 | 0.0 | 0.0 |
| BIP-BIP | 1.0 | 1.0 | — | 0.0 | 0.99 | 0.0 | 0.70 | 0.0 |
| BIP-HBMv | 1.0 | 1.0 | 1.0 | — | 1.0 | 0.0 | 1.0 | 0.0 |
| HBMv-BIP | 1.0 | 1.0 | 0.01 | 0.0 | — | 0.0 | 0.0 | 0.0 |
| HBMv- | 1.0 | 1.0 | 1.0 | 1.0 | 1.0 | — | 1.0 | 0.0 |
| HBMv | | | | | | | | |
| HBMc-BIP | 1.0 | 1.0 | 0.30 | 0.0 | 1.0 | 0.0 | — | 0.0 |
| HBMc-HBMv | 1.0 | 1.0 | 1.0 | 1.0 | 1.0 | 1.0 | 1.0 | — |

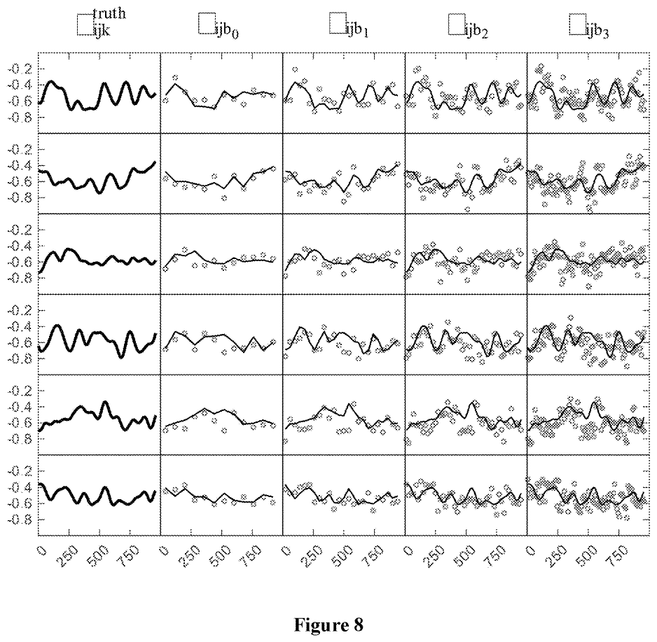

FIG. 8 illustrates an exemplary set of graphical representations of results from one-dimensional random Gaussian function. Black line indicates the true latent function; colored lines indicates posterior means from the four models across layers. FIG. 8 is shown to illustrate recovery of a simple 1D function; HBMc-HBMv provides the most accurate and stable estimates across all resolution layers, directly supporting the scalability and precision-under-sparsity claims. Results from six of the 36 subjects. Each row represents one subject, where column 1 is true latent variables

$${θ}_{ijk}^{truth} ,$$

and columns 2, 3, 4 and 5 are θ_{ijb}_{ᵢ} at the top, first, second, and third layer of a parameter pyramid, according to an exemplary embodiment of the present disclosure.

Specifically, FIG. 8 shows true and estimated latent variables from the first six subjects. Table 5 presents the exemplary root-mean-square error (RMSE) and standard deviation (SD) for all eight models across four resolutions. In table 5, the bold font indicates the best (lowest) RMSE or SD value in each column. This table is shown to evaluate the three core claims (scalability, precision under sparsity, interpretability); HBMc-HBMv consistently outperforms BIP and the other variants. Across all layers, HBMv-HBMv and HBMc-HBMv consistently delivered the smallest RMSE values, with HBMv-HBMv leading in Layers 0-2 and HBMc-HBMv in Layer 3. For SD, HBMc-HBMv can outperform all models at every layer, achieving the smallest values (e.g., 0.0269 to 0.0941), with HBMv-HBMv as a close second. HBMc-HBMv reduced RMSE by e.g., an average of 66.8% and SD by 78.5% compared to BIP, highlighting its effectiveness in improving accuracy and precision across all resolution layers. The reduction was most pronounced at higher layers (Layer 3), where sparse data challenges simpler models like BIP the most.

As shown in FIG. 8, the exemplary systems, methods, and computer accessible medium according to the exemplary embodiments of the present disclosure can illustrate recovery of a one-dimensional random Gaussian function. FIG. 8 can present results from six of the 36 subjects, with each row representing one subject. A first column can display the true latent variables, and columns two through five can display estimated parameters at the top, first, second, and third layers of a parameter pyramid, respectively. The x-axis of each panel can represent the index position, while the y-axis can represent the latent parameter values. First lines in the first column can show smooth oscillating patterns representing the ground truth, while markers in subsequent columns can show the posterior mean reconstructions at progressively finer resolutions. As resolution can increase from the top layer to the third layer, the number of data points can increase correspondingly, with the estimates tracking the underlying true function with varying degrees of accuracy across the different subjects and layers. HBMc-HBMv can provide the most accurate and stable estimates across all resolution layers, directly supporting the scalability and precision-under-sparsity claims of the framework.

TABLE 5
Exemplary RMSE and Standard Deviations in Test 1.

| | RMSE | | | | SD | | | |
|---|---|---|---|---|---|---|---|---|
| Model | Layer 0 | Layer 1 | Layer 2 | Layer 3 | Layer 0 | Layer 1 | Layer 2 | Layer 3 |
| BIP | 0.1666 | 0.2401 | 0.3209 | 0.4013 | 0.1327 | 0.1943 | 0.2761 | 0.4018 |
| HBMv | 0.0637 | 0.0853 | 0.1599 | 0.2158 | 0.0632 | 0.0902 | 0.1617 | 0.2428 |
| BIP-BIP | 0.0998 | 0.1308 | 0.1627 | 0.1786 | 0.0483 | 0.0718 | 0.1104 | 0.1643 |
| BIP-HBMv | 0.0691 | 0.0872 | 0.1045 | 0.1169 | 0.0307 | 0.0438 | 0.0652 | 0.1004 |
| HBMv-BIP | 0.0792 | 0.1127 | 0.1474 | 0.1658 | 0.0404 | 0.0635 | 0.1015 | 0.1560 |
| HBMv-HBMv | 0.0650 | 0.0829 | 0.0998 | 0.1116 | 0.0274 | 0.0404 | 0.0610 | 0.0946 |
| HBMc-BIP | 0.0797 | 0.1129 | 0.1476 | 0.1660 | 0.0399 | 0.0632 | 0.1012 | 0.1558 |
| HBMc-HBMv | 0.0654 | 0.0831 | 0.0999 | 0.1115 | 0.0269 | 0.0400 | 0.0606 | 0.0941 |

### Exemplary Test 2. Learning Curves in Face View Discrimination

Perceptual learning can enhance performance on perceptual tasks through practice, with learning curves typically derived from aggregated trial or session data (see, e.g., Refs. 32, 44, 69, 92). These curves can often reflect average accuracy or response time in constant stimuli paradigms (see, e.g., Refs. 7, 34, 56) or thresholds in adaptive training (see, e.g., Refs. 29, 33, 83, 118), but aggregation can obscure trial-by-trial dynamics (see, e.g., Refs. 16, 121).

To address this, researchers can use parametric methods to model psychometric parameters over time (see, e.g., Refs. 25, 126) or non-parametric approaches like hierarchical Bayesian modeling for small blocks (see, e.g., Ref. 131). For example, the exemplary systems, methods, and computer accessible medium according to the exemplary embodiments of the present disclosure can apply a pyramid-based multi-resolution framework—a non-parametric method—to extract high-resolution learning curves from a face view discrimination dataset (see, e.g., Ref. 122), revealing detailed learning processes.

Dataset: The dataset can comprise e.g., 49 healthy adult subjects who completed a face view discrimination task over five daily sessions, each with seven blocks of e.g., 100 trials, totaling 3,500 trials per subject. Participants can view stimuli binocularly at a 4-meter distance. A 3D face model (hairless), generated via e.g., FaceGen Modeler 3.1 (www.facegen.com), can be rotated in depth from a 0° front view to create stimuli, projected onto a monitor. Each trial can present two face views (e.g., 300 and 30°±c°) for 100 ms, separated by a e.g., 1,400-ms blank interval, with randomized presentation order and spatial positions within an e.g., 1.43°×1.43° area centered at the fixation point. Subjects can perform a two-alternative forced-choice (2AFC) task, judging the second face's orientation relative to the first. A three-down/one-up staircase, targeting e.g., 79.4% accuracy, can adjust the view difference c°: decreasing by e.g., 10% after three consecutive correct responses and increasing by e.g., 10% after an incorrect response, starting at e.g., 8°. Auditory feedback can reinforce correct answers during training.

Exemplary Model Specification: The generative function for trial-by-trial responses followed Eqs. 31a,b, where cᵢⱼₖ represents the face view difference from 30°. The exemplary systems, methods, and computer accessible medium according to the exemplary embodiments of the present disclosure can construct a three-layer parameter pyramid [symbol] _{θ} with resolutions e.g., B₀=35 (top layer), B₁=70 (Layer 1), and B₂=140 (Layer 2), enabling coarse-to-fine estimation of latent thresholds. Prior distributions for the BIP, HBMv, and HBMc models in [symbol] _{θ} and [symbol] _{δ} are detailed in Table 6

TABLE 6
Exemplary Priors in Test 2 (perceptual learning).

| | | |
|---|---|---|
| [symbol] θ | BIP | p₀(θ_{ijb}_{ₗ}) = U(lb, ub), lb = −1.0, ub = 1.0 |
| | | i ϵ [1, 49], j = 1, bₗϵ [1, Bₗ], l ϵ [0, 2] |
| | | p₀(κ) = U(lb, ub), b = 1, ub = 3 |
| | HBMv | p₀(μ_{b}_{ₗ}) = U(lb, ub), lb = −1.0, |
| | | ub = 1.0, bₗϵ [1, Bₗ], l ϵ [0, 2] |
| | | p₀(σ_{b}_{ₗ}) = Γ(αₚₒₚ, βₚₒₚ), p₀(ε_{b}_{ₗ}) = Γ(α_{ind}, β_{ind}), |
| | | αₚₒₚ = 2.0, α_{ind} = 2.0, βₚₒₚ = 10, β_{ind} = 10 |
| | | p₀(κ) = U(lb, ub), lb = 1, ub = 3 |
| | HBMc | p₀(μ) = U(^{(B}^{₀}⁾)(lb, ub), lb = −1.0, ub = 1.0 |
| | | p₀(sd_dist0) = ε(λ₀, B₀), p₀(Σ) = |
| | | LKJCov(v₀, sd_dist0, B₀), λ₀ = 8.0, v₀ = 2.0 |
| | | p₀(ε_{b}_{₀}) = Γ(α_{ind}, β_{ind}), α_{ind} = 3.0, β_{ind} = 10 |
| | | p₀(κ) = U(lb, ub), lb = 1, ub = 3 |
| [symbol] δ | BIP | p₀(δθ_{ijb}_{ₗ}) = U(δ_{lb}_{ₗ}, δu_{lb}_{ₗ}), i ϵ [1, 49], |
| | | j = 1, bₗϵ [1, Bₗ] l ϵ [0, 1] |
| | | δ_{lb}_{ₗ} = −0.25, δubₗ = 0.25 |
| | HBMv | p₀(δμ_{b}_{ₗ}) = U(δlbₗ, δμ_{b}_{ₗ}), i ϵ [1, 49], bₗϵ [1, Bₗ] l ϵ [0, 1] |
| | | δlbₗ = −0.25, δubₗ = 0.25 |
| | | p₀(δσ_{b}_{ₗ}) = Γ(δα_{pop,l}, δβ_{pορ,l}), p₀(δε_{b}_{ₗ}) = Γ(δα_{ind}, δβ_{ind,l}) |
| | | δα_{pop,l} = 2.0, δα_{ind,l} = 2.0, δβ_{pop,l} = 10, δβ_{ind,l} = 10 |

Results: The results of this exemplary validation test can demonstrate the three core claims of the framework on perceptual learning curves using B blocks and I subjects, where θ represents the subject-level latent parameter and Δy (or δ) the difference parameters in the difference pyramid (see Table 2 for notations): (1) the pyramid structure dramatically reduces computational cost (scalability), (2) HBMc-HBMv reliably recovers the learning trajectory even under sparse sampling conditions (precision under sparsity; main analyses used a minimum of 25 trials per block), and (3) the multi-resolution layers provide complementary information that improves interpretability of coarse trends versus fine details.

Weights from pairwise model comparisons (WAIC weights, which can be interpreted as the relative probability that a given model is the best among those compared) are summarized in Table 7. HBMc-HBMv dominates, winning 7/7 comparisons (weight=1.0) against all others. HBMv-HBMv is a close second, winning 6/7 (loses only to HBMc-HBMv, weight=0.0). BIP-HBMv and HBMv-BIP won 5/7 and 4/7 respectively, losing to top models. HBMc-BIP won 4/7, outperformed by HBMc-HBMv, HBMv-HBMv, and BIP-HBMv. BIP-BIP won 3/7, with a near tie against HBMv (e.g., 0.99 vs. 0.01). HBMv won 1/7 (only vs. BIP), and BIP lost all 7 (weight=0.0). In this test according to the exemplary systems, methods, and computer accessible medium according to the exemplary embodiments of the present disclosure, HBMc-HBMv is the clear leader, followed by HBMv-HBMv. BIP is the weakest. HBMc-HBMv is the clear leader with decisive support in every pairwise comparison, confirming the advantage of top-layer covariance combined with hierarchical refinement. HBMv-HBMv follows closely as a strong runner-up, while models lacking hierarchy (especially fully independent BIP) receive essentially no support in head-to-head tests. This pattern robustly supports the framework's claims of scalability, precision under sparsity, and enhanced multi-resolution interpretability

TABLE 7
Exemplary Model Weights in Test 2 (perceptual learning curves, face-view discrimination task).

| Model | BIP | HBMv | BIP-BIP | BIP-HBMv | HBMv-BIP | HBMv-HBMv | HBMc-BIP | HBMc-HBMv |
|---|---|---|---|---|---|---|---|---|
| BIP | — | 0.0 | 0.0 | 0.0 | 0.0 | 0.0 | 0.0 | 0.0 |
| HBMv | 1.0 | — | 0.01 | 0.0 | 0.0 | 0.0 | 0.0 | 0.0 |
| BIP-BIP | 1.0 | 0.99 | — | 0.0 | 0.0 | 0.0 | 0.0 | 0.0 |
| BIP-HBMv | 1.0 | 1.0 | 1.0 | — | 1.0 | 0.0 | 1.0 | 0.0 |
| HBMv-BIP | 1.0 | 1.0 | 1.0 | 0.0 | — | 0.0 | 0.0 | 0.0 |
| HBMv-HBMv | 1.0 | 1.0 | 1.0 | 1.0 | 1.0 | — | 1.0 | 0.0 |
| HBMc-BIP | 1.0 | 1.0 | 1.0 | 0.0 | 1.0 | 0.0 | — | 0.0 |
| HBMc-HBMv | 1.0 | 1.0 | 1.0 | 1.0 | 1.0 | 1.0 | 1.0 | — |

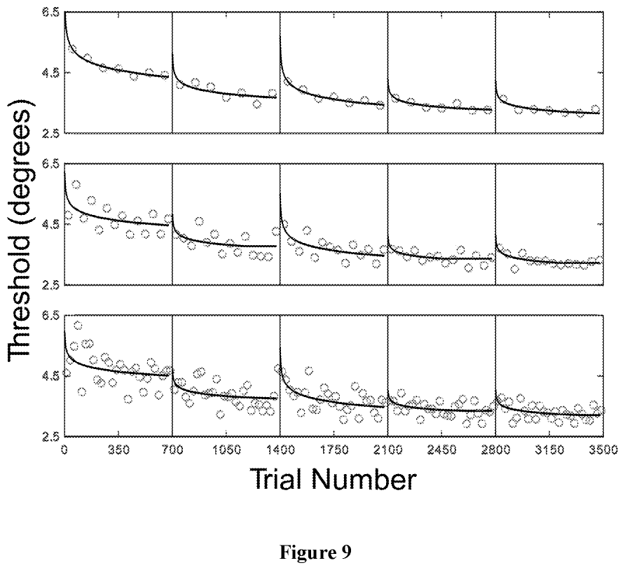

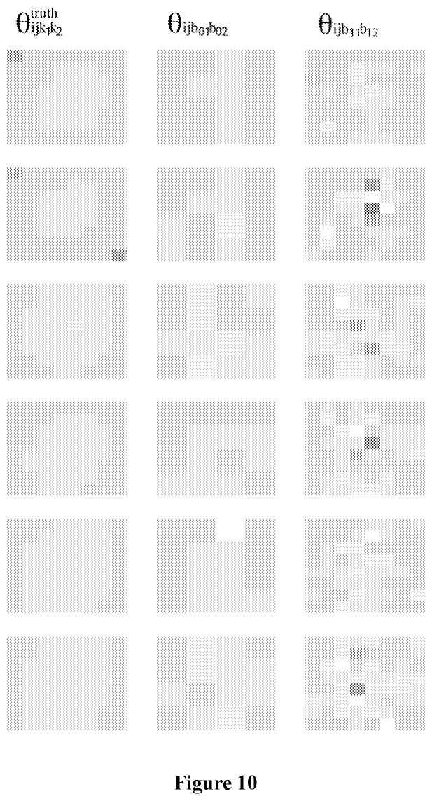

FIG. 9 illustrates an exemplary set of graphical representation of estimated learning curves at the top, first, and second layers of a pyramid in accordance with certain exemplary embodiments of the present disclosure. For example, each panel displays average thresholds over training blocks for the four main model classes (BIP, HBMv, HBMc, and pyramid variants) at different resolutions. FIG. 9 is provided to illustrate how additional pyramid layers reveal complementary information-coarse layers capture overall trends, while finer layers recover local details in the generative learning function. Exemplary results are averaged across subjects to highlight model differences in stability and accuracy.

Specifically, FIG. 9 shows exemplary average learning curves at three resolutions. Table 8 shows the standard deviations (SD) for all eight models across three resolutions. HBMc-HBMv consistently achieved the smallest SD across all layers, with values ranging from e.g., 0.0214 (Layer 0) to e.g., 0.0493 (Layer 2), indicating the highest precision in estimates. HBMv-HBMv and BIP-HBMv followed closely, with HBMv-HBMv slightly outperforming BIP-HBMv in Layers 0 and 1. In contrast, the BIP model exhibited the largest SD at every layer (e.g., 0.0992 to 0.2178). HBMc-HBMv reduced SD by an average of e.g., 77.7% compared to BIP, demonstrating significant improvement in precision across all resolution layers, with consistent benefits as resolution increases.

As shown in FIG. 9, the exemplary systems, methods, and computer accessible medium according to the exemplary embodiments of the present disclosure can illustrate estimated learning curves at the top, first, and second layers of a pyramid. FIG. 9 can comprise three vertically stacked panels, each displaying average thresholds in degrees on the vertical axis plotted against trial number on the horizontal axis. Each panel can show data points represented as markers, with a fitted curve overlaid to illustrate the underlying trend. A top panel can display threshold values showing a decreasing trend from higher initial values that can stabilize as trial number increases, representing the coarsest resolution of the learning curve. A middle panel can present a similar range and pattern, with threshold estimates showing comparable decreasing behavior over the course of training at an intermediate resolution. A bottom panel can exhibit greater variability in the data points compared to the upper panels, with threshold values fluctuating more substantially around the fitted curve while still demonstrating an overall decreasing trend, representing the finest resolution. The fitted curves in each panel can represent posterior mean reconstructions from the models, while the markers can indicate estimated threshold values at each resolution layer. Additional pyramid layers can reveal complementary information, where coarse layers can capture overall trends and finer layers can recover local details in the generative learning function, with results averaged across subjects to highlight model differences in stability and accuracy.

TABLE 8
Exemplary Standard Deviations in Test 2.

| | SD | | |
|---|---|---|---|
| Model | Layer 0 | Layer 1 | Layer 2 |
| BIP | 0.0992 | 0.1419 | 0.2178 |
| HBMv | 0.0808 | 0.1053 | 0.1411 |
| BIP-BIP | 0.0592 | 0.0908 | 0.1429 |
| BIP-HBMv | 0.0245 | 0.0354 | 0.0528 |
| HBMv-BIP | 0.0548 | 0.0880 | 0.1411 |
| HBMv-HBMv | 0.0235 | 0.0344 | 0.0516 |
| HBMc-BIP | 0.0507 | 0.0850 | 0.1390 |
| HBMc-HBMv | 0.0214 | 0.0323 | 0.0493 |

### Exemplary Test 3. Two-Dimensional Visual Field Map

This simulation of the exemplary systems, methods, and computer accessible medium according to the exemplary embodiments of the present disclosure modeled light sensitivity across the visual field by fitting a polynomial function to perimetry data from the right eyes of the first e.g., 36 subjects in an open-source dataset of healthy adults. The dataset, collected via static automated perimetry, can span the full visual field. The best-fitting polynomials generated “true” light sensitivity maps on an e.g., 8×8 grid for each subject. A 2-down/1-up staircase procedure can be used to define trial-by-trial stimulus levels and generating binary responses.

Simulated Dataset: The original perimetry dataset included e.g., 64 luminance sensitivity measurements (1/threshold) across 64 locations (e.g., 26°-81° peripheral visual field) from e.g., 98 eyes of 98 subjects, each tested twice. For this validation test, the exemplary systems, methods, and computer accessible medium according to the exemplary embodiments of the present disclosure can average the two test results for each right eye, excluding the blind spot, yielding sensitivity values

$${z}_{i}^{0}$$

at spatial coordinates

$$( {x}_{i , 1 : {K}_{1} , 1 : {K}_{2}}^{0} , {y}_{i , 1 : {K}_{1} , 1 : {K}_{2}}^{0} ) .$$

A 2nd-order polynomial can be fitted to these using e.g., MATLAB's fit2dPolySVD function:

$${e}_{i} = fit 2 dPolySVD ( {x}_{i , 1 : {K}_{1} , 1 : {K}_{2}}^{0} , {y}_{i , 1 : {K}_{1} , 1 : {K}_{2}}^{0} , {z}_{i , 1 : {K}_{1} , 1 : {K}_{2}}^{0} , 2 ) . \qquad ( 32 )$$

“True” thresholds (log₁₀ units) can be computed on an e.g., 8×8 grid [x,y]=meshgrid(−50: 18: 76, −44: 10: 26) for each subject i:

$${θ}_{i 1 , {k}_{1} {k}_{2}}^{true} = - {log}_{10} ( {e}_{i} ( 1 ) + {e}_{i} ( 2 ) {y}_{{k}_{2}} + {e}_{i} ( 3 ) {y}_{{k}_{2}}^{2} + {e}_{i} ( 4 ) {x}_{{k}_{1}} + {e}_{i} ( 5 ) {x}_{{k}_{2}}^{2} + {e}_{i} ( 6 ) {x}_{{k}_{1}} {y}_{{k}_{2}} ) . \qquad ( 33 )$$

Each of the 64 locations underwent 20 trials in a 2AFC task, with performance governed by a Weibull psychometric function:

$$p ( {r}_{i j {k}_{1} {k}_{2} m} = 1 \vert {θ}_{{ijk}_{1} {k}_{2}}^{truth} , {κ}^{truth} , {c}_{{ijk}_{1} {k}_{2} m} ) = γη + ( 1 - η ) ( γ + ( 1 - γ ) ( 1 - exp ( - {( \frac{{c}_{{ijk}_{1} {k}_{2} m}}{{10}^{{θ}_{{ijk}_{1} {k}_{2}}^{truth} - \frac{1}{{β}^{truth}} lo {g}_{10} ( lo g ( \frac{1 - γ}{1 - {p}_{1.5}} ) )}} )}^{{κ}^{truth}} ) ) ) , \qquad ( 34 a )$$

$$p ( {r}_{{ijk}_{1} {k}_{2} m} = 0 \vert {θ}_{{ijk}_{1} {k}_{2}}^{truth} , {κ}^{truth} , {c}_{{ijk}_{1} {k}_{2} m} ) = 1 - p ( {r}_{{ijk}_{1} {k}_{2} m} = 1 \vert {θ}_{{ijk}_{1} {k}_{2}}^{truth} , {κ}^{truth} , {c}_{{ijk}_{1} {k}_{2} m} ) , \qquad ( 34 b )$$

where m∈[1,20] is trial number, γ=0.5 (guessing rate), η=0.04 (lapse rate), p_{1.5}=0.856 (correct probability at d′=1.5), and κ^{truth} is the slope. Contrast cᵢⱼₖ_{₁}ₖ_{₂}ₘ was adjusted via a 2-down/1-up staircase: reduced by 0.9 after two consecutive correct responses, increased by 1.1 after an incorrect response, starting at 0.043.

### Exemplary Model Specification:

The model of the generative function for responses mirrored Eqs. 7a,b:

where rᵢⱼₖ_{₁}ₖ_{₂}ₘ is the binary outcome,

$$p ( {r}_{{ijk}_{1} {k}_{2} m} = 1 \vert {θ}_{{ijk}_{1} {k}_{2}} , κ , {c}_{{ijk}_{1} {k}_{2} m} ) = γη + ( 1 - η ) ( γ + ( 1 - γ ) ( 1 - exp ( - {( \frac{{c}_{{ijk}_{1} {k}_{2} m}}{{10}^{{θ}_{{ijk}_{1} {k}_{2}} - \frac{1}{κ} l {og}_{10} ( lo g ( \frac{1 - γ}{1 - {p}_{1.5}} ) )}} )}^{κ} ) ) ) , \qquad ( 35 a )$$

$$p ( {r}_{{ijk}_{1} {k}_{2} m} = 0 \vert {θ}_{{ijk}_{1} {k}_{2}} , κ , {c}_{{ijk}_{1} {k}_{2} m} ) = 1 - p ( {r}_{{ijk}_{1} {k}_{2} m} = 1 \vert {θ}_{{ijk}_{1} {k}_{2}} , κ , {c}_{{ijk}_{1} {k}_{2} m} ) . \qquad ( 35 b )$$

is the threshold, K is the slope to estimate, and

$${θ}_{ij , {k}_{1} {k}_{1}}^{true}$$

cᵢⱼₖ_{₁}ₖ_{₂}ₘ is the contrast, with γ, η, and p_{1.5} as defined above.

The exemplary systems, methods, and computer accessible medium according to the exemplary embodiments of the present disclosure can construct a two-layer pyramid [symbol] _{θ}: top layer (B₀₁=4, B₀₂=4), Layer 1 (B₁₁=8, B₁₂=8). Priors for BIP, HBMv, and HBMc models in [symbol] _{θ} and [symbol] _{δ} are in Table 9. Furthermore, in Table 9, U(lb,ub) denotes a uniform distribution with lower limit lb and upper limit ub. r(α,β) represents a gamma distribution with shape parameter α and rate parameter β. U^{(B}^{₀₁}^{B}^{₀₂}⁾(lb,ub) refers to a (B₀₁×B₀₂)-dimensional uniform distributions, where each dimension has a lower limit lb and upper limit ub. E(λ,B₀₁B₀₂) represents a (B₀₁×B₀₂)-dimensional exponential distribution with rate parameter A. LKJCov(v,sd_dist,B₀₁B₀₂) denotes a distribution over Cholesky decomposed (B₀₁×B₀₂)×(B₀₁×B₀₂) covariance matrices, with rate parameter v and standard deviation distribution sd_dist.

TABLE 9
Exemplary Priors in Test 3.

| | | |
|---|---|---|
| [symbol] θ | BIP | p₀(θ_{ijb}_{ₗ₁}_{,b}_{ₗ₂}) = U(lb, ub), lb = −3.0, |
| | | ub = −0.5, i ϵ [1, 20], j ϵ [1, 4], |
| | | bₗ₁ϵ [1, Bₗ₁], bₗ₂ϵ [1, Bₗ₂] l ϵ [0, 1] |
| | | p₀(κ) = U(lb, ub), lb = 1, ub = 3 |
| | HBMv | p₀(μ_{ijb}_{ₗ₁}_{,b}_{ₗ₂}) = U(lb, ub), lb = −3.0, |
| | | ub = −0.5, i ϵ [1, 20], bₗ₁ϵ [1, |
| | | Bₗ₁], bₗ₂ϵ [1, Bₗ₂] l ϵ [0, 1] |
| | | p₀(σ_{b}_{ₗ₁}_{,b}_{ₗ₂}) = Γ(αₚₒₚ, βₚₒₚ), p₀(ε_{b}_{ₗ₁}_{,bl}_{₂}) = |
| | | Γ(α_{ind}, β_{ind}), αₚₒₚ = 2.5, |
| | | α_{ind} = 2.5, βₚₒₚ = 10, β_{ind} = 10 |
| | | p₀(κ) = U(lb, ub), lb = 1, ub = 3 |
| | HBMc | p₀(μ) = U^{(B}^{₀₁}^{B}^{₀₂}⁾(lb, ub), |
| | | lb = −3.0, ub = −0.5 |
| | | p₀(sd_dist1) = ε(λ₁, B₀₁B₀₂), p₀(Σ) = |
| | | LKJCov(v₁, sd_dist1, |
| | | B₀₁B₀₂), λ₁ = 2.5, v₁ = 2.0 |
| | | p₀(ε_{b}_{ₗ₁}_{,b}_{ₗ₂}) = Γ(α_{ind}, β_{ind}), |
| | | α_{ind} = 2.5, β_{ind} = 10 |
| | | p₀(κ) = U(lb, ub), , lb = 1, ub = 3 |
| [symbol] δ | BIP | p₀(δθ_{ijb}_{ₗ₁}_{,b}_{ₗ₂}ⁿ) = U(δlb, δub), i ϵ [1, 20], |
| | | j ϵ [1, 4], n ϵ [1, 3], bₗ₁ϵ [1, |
| | | Bₗ₁], bₗ₂ϵ [1, Bₗ₂], l = 0 |
| | | δlb = −0.30, δub = 0.30 |
| | HBMv | p₀(δμ_{b}_{ₗ₁}_{,b}_{ₗ₂}) = U(δlb, δub), δlb = −0.30, |
| | | δub = 0.30, bₗ₁ϵ [1, Bₗ₁], bₗ₂ϵ [1, Bₗ₂], l = 0 |
| | | p₀(δσ_{b}_{ₗ₁}_{,b}_{ₗ₂}) = Γ(δαₚₒₚ, δβₚₒₚ), |
| | | p₀(δε_{b}_{ₗ₁}_{,b}_{ₗ₂}) = Γ(δα_{ind}, δβ_{ind}) |
| | | δαₚₒₚ = 2.5, δα_{ind} = 2.5, |
| | | δβₚₒₚ = 10, δβ_{ind} = 10 |

Exemplary Results: The results of this exemplary validation test can demonstrate the three core claims of the framework on 2D visual field maps using B blocks and I subjects, where θ represents the subject-level latent parameter and Δy (or δ) the difference parameters (see Table 2): the pyramid structure dramatically reduces computational cost (scalability), HBMc-HBMv reliably recovers the true sensitivity map under sparse sampling conditions (precision under sparsity; main analyses used a minimum of 20 trials per location), and the multi-resolution layers provide complementary information that improves interpretability of coarse trends versus fine details.

Table 10 presents weights from pairwise model comparisons. HBMc-HBMv is the top performer, with a weight of 1.0 in all 7 comparisons against the other models, indicating it consistently outperforms them. HBMv-HBMv is a close second, winning 6 out of 7 comparisons (weight=1.0), only losing to HBMc-HBMv (weight=0.0). HBMv and BIP-HBMv are competitive, with HBMv winning 5/7 (weight=1.0) and BIP-HBMv winning 4/7, but they split weights (0.60 vs. 0.40) against each other, showing near-equivalence. HBMv-BIP and HBMc-BIP perform moderately, each winning 3/7 comparisons (weight=1.0 against BIP, BIP-BIP, and one other), but losing to the top HBM models. BIP-BIP is weak, winning only against BIP (weight=1.0), with 0.0 elsewhere. BIP is the weakest, with a weight of 0.0 in all 7 comparisons, losing to every other model. In short, HBMc-HBMv dominates, followed closely by HBMv-HBMv, while BIP is consistently the least preferred.

TABLE 10
Exemplary Model Weights in Test 3 (visual field map).

| Model | BIP | HBMv | BIP-BIP | BIP-HBMv | HBMv-BIP | HBMv-HBMv | HBMc-BIP | HBMc-HBMv |
|---|---|---|---|---|---|---|---|---|
| BIP | — | 0.0 | 0.0 | 0.0 | 0.0 | 0.0 | 0.0 | 0.0 |
| HBMv | 1.0 | — | 1.0 | 0.60 | 1.0 | 0.0 | 1.0 | 0.0 |
| BIP-BIP | 1.0 | 0.0 | — | 0.0 | 0.0 | 0.0 | 0.0 | 0.0 |
| BIP-HBMv | 1.0 | 0.40 | 1.0 | — | 1.0 | 0.0 | 1.0 | 0.0 |
| HBMv-BIP | 1.0 | 0.0 | 1.0 | 0.0 | — | 0.0 | 1.0 | 0.0 |
| HBMv-HBMv | 1.0 | 1.0 | 1.0 | 1.0 | 1.0 | — | 1.0 | 0.0 |
| HBMc-BIP | 1.0 | 0.0 | 1.0 | 0.0 | 0.0 | 0.0 | — | 0.0 |
| HBMc-HBMv | 1.0 | 1.0 | 1.0 | 1.0 | 1.0 | 1.0 | 1.0 | — |

FIG. 10 illustrates an exemplary set of graphical representations of results from six subjects where column 1 is true latent variables

$${θ}_{{ijk}_{1} {k}_{2}}^{truth}$$

and Columns 2 and 3 are θ_{ijb}_{ₗ₁}_{b}_{ₗ₂} at the top and first layers of a parameter pyramid according to an exemplary embodiment of the present disclosure. For example, each panel shows sensitivity maps reconstructed by the four models at different pyramid layers. The color scale indicates estimated log₁₀ sensitivity (brighter hues correspond to higher sensitivity; plotted values range from −1.70 to −1.02). FIG. 10 is provided to illustrate a recovery of 2D spatial functions; the data are sparse (20 trials per location). Meaningful structure (recovery of the true VFM) improves progressively across layers, with the hierarchical pyramid jointly contributing to the final estimate and HBMc-HBMv providing the best accuracy.

Specifically, FIG. 10 displays the true and estimated VFMs for the first six of 36 subjects. Each VFM represents light sensitivity thresholds across an 8×8 grid of retinal locations, measured using 20 trials per location to limit test duration. Due to the limited number of trials, the recovered VFMs exhibit relatively high variability, particularly at higher resolutions, reflecting the trade-off between test brevity and estimation precision.

As shown in FIG. 10, the exemplary systems, methods, and computer accessible medium according to the exemplary embodiments of the present disclosure can illustrate visual field maps from a perimetry dataset, showing sensitivity maps reconstructed by different models at different pyramid layers. FIG. 10 can be organized as a grid with six rows and three columns, where each row can represent results from one subject. A first column can display the true latent variables at the highest resolution. A second column can show estimated parameters at the top layer of a parameter pyramid. A third column can present estimated parameters at the first layer of the parameter pyramid. A shading scale can indicate estimated log base ten sensitivity, where lighter shading can correspond to higher sensitivity. The data can be sparse with approximately 20 trials per location. Meaningful structure and recovery of the true visual field map can improve progressively across layers, with the hierarchical pyramid jointly contributing to the final estimate.

TABLE 11
Exemplary RMSE and Standard Deviations in Test 3.

| | RMSE | | SD | |
|---|---|---|---|---|
| Model | Layer 0 | Layer 1 | Layer 0 | Layer 1 |
| BIP | 0.1003 | 0.2884 | 0.1107 | 0.2697 |
| HBMv | 0.0330 | 0.0546 | 0.0393 | 0.0717 |
| BIP-BIP | 0.1052 | 0.1620 | 0.0811 | 0.1868 |
| BIP-HBMv | 0.0665 | 0.0812 | 0.0481 | 0.0853 |
| HBMv-BIP | 0.0627 | 0.1382 | 0.0592 | 0.1759 |
| HBMv-HBMv | 0.0419 | 0.0601 | 0.0311 | 0.0664 |
| HBMc-BIP | 0.0665 | 0.1401 | 0.0603 | 0.1764 |
| HBMc-HBMv | 0.0432 | 0.0611 | 0.0312 | 0.0665 |

Table 11 presents the root-mean-square error (RMSE) and standard deviation (SD) for all eight models across two resolutions. HBMv consistently achieved the smallest RMSE across both layers, with values of e.g., 0.0330 (Layer 0) and e.g., 0.0546 (Layer 1), indicating the highest accuracy in estimating the latent variables. HBMv-HBMv and HBMc-HBMv followed closely, particularly in Layer 1. For SD, HBMv-HBMv outperformed all models in both layers, with the smallest values of e.g., 0.0311 (Layer 0) and e.g., 0.0664 (Layer 1), demonstrating superior precision, though HBMc-HBMv was nearly identical in both layers. In contrast, the BIP model exhibited the largest errors, with RMSE up to e.g., 0.2884 and SD up to e.g., 0.2697, highlighting the advantage of hierarchical models like HBMv, HBMv-HBMv, and HBMc-HBMv in this experiment. HBMv reduced RMSE by an average of e.g., 74.1% and HBMc-HBMv/HBMv-HBMv reduced SD by e.g., 73.7% compared to BIP, demonstrating significant improvements in accuracy and precision across both layers, with the largest gains at Layer 1 where data sparsity challenged simpler models like BIP.

### Exemplary Test 4. Longitudinal CSF

This validation simulation modeled a longitudinal contrast sensitivity function (CSF) dataset to emulate clinical trial conditions, tracking visual sensitivity changes over time for 36 subjects. Power functions were fitted to CSF parameters-peak gain, peak frequency, and bandwidth-extracted from qCSF measurements of 112 healthy subjects under four luminance conditions (see, e.g., Ref. 52), treating these as observations at time points t=1, 9, 17, and 24. The best-fitting power functions for the first 36 subjects generated 24 CSF tests per subject using the qCSF procedure (see, e.g., Refs. 51, 64), producing 25 trials per time point to capture realistic variability. This simulation estimated contrast sensitivities (CS) non-parametrically at six FDA-designated spatial frequencies (see, e.g., Ref. 129): 1.0, 1.5, 3.0, 6.0, 12.0, and 18.0 cycles per degree (cpd). The latent variables are the CS values at these frequencies. For 36 subjects across 24 time points, trial-by-trial qCSF data were binned by stimulus frequency, yielding 6 frequencies×24 time points=144 latent variables per subject to capture the CSF's temporal evolution.

Exemplary Simulated Dataset: The power functions interpolated a smooth trajectory of CSF parameters over 24 equally spaced time points for each of the 36 simulated subjects. The qCSF procedure, a Bayesian active learning method, simulated 25 CSF trials per time point, resulting in 24 tests per subject (600 trials total). Stimuli were ten Sloan letters (C, D, H, K, N, O, R, S, V, Z), each filtered with a raised cosine filter:

$$F ( f ) = \{ \begin{matrix}0 , & f < \frac{{f}_{0}}{2} ⋁ f > 2 {f}_{0} \\ \frac{1}{2} + \frac{1}{2} cos ( \frac{log ( \frac{f}{{f}_{0}} )}{log ( \frac{{f}_{cutoff}}{{f}_{0}} )} π ) , & f ∈ [ \frac{{f}_{0}}{2} , 2 {f}_{0} ] ,\end{matrix} \qquad ( 36 )$$

where f is the radial spatial frequency, f₀=3 cycles per object is the center frequency, and f_{cutoff}=2f₀ ensures that the full bandwidth at half height spans one octave. Each filtered letter image was normalized by its maximum absolute intensity, resulting in a maximum Michelson contrast of 1.0 after normalization. Stimulus contrast values, ranging from 0.002 to 1 in 128 equal logarithmic steps, were generated by scaling the normalized images. Nineteen spatial frequencies, ranging from 1.19 to 30.95 cycles per degree, were obtained by resizing. Each qCSF test presented 25 rows of three bandpass-filtered optotypes, randomly sampled from the Sloan letters, with sizes and contrasts optimized by the qCSF method. Unlike conventional approaches that adapt stimuli only in contrast space, qCSF optimizes both contrast and spatial frequency, maximizing information gain per trial. This Bayesian algorithm selects optimal stimuli, updates posterior probabilities of CSF parameters based on responses, and directly estimates the full CSF curve.

Exemplary Model Specification: The 19 spatial frequencies can be binned in the qCSF dataset into the six FDA-designated SFs (Table 12). For example, the nominal 1.5 cpd bin includes stimuli at 1.43, 1.71, and 2.05 cpd, while the 18.0 cpd bin spans 17.98 to 30.95 cpd. The generative model for subject i, test j, at time point k, defines a 6-dimensional parameter θᵢⱼₖ, representing CS at each FDA-designated SF. Table 12 can define how the 19 raw stimulus frequencies can be grouped into the standard six clinical spatial-frequency bands.

TABLE 12
Exemplary bins for the six FDA-designated
spatial frequencies.

| Nominal SF | Stimulus SFs |
|---|---|
| 1 | 1.19 |
| 1.5 | 1.43, 1.71, 2.05 |
| 3 | 2.45, 2.94, 3.53, 4.23 |
| 6 | 5.06, 6.07, 7.27, 8.72, |
| 12 | 10.44, 12.52, 15.00 |
| 18 | 17.98, 21.55, 25.83, 30.95 |

The probability of obtaining a correct followed a psychometric function:

$$p ( {r}_{ijkol} = 1 \vert {θ}_{ijk} , {f}_{ijko} , {c}_{ijkol} ) = γ + ( 1 - γ ) ( 1 - η ) Φ ( \frac{{log}_{10} ( {c}_{ijkol} ) + {log}_{10} ( {θ}_{ijk}^{{f}_{ijko}} )}{κ} ) , \qquad ( 37 a )$$

$$p ( {r}_{ijkol} = 0 \vert {θ}_{ijk} , {f}_{ijko} , {c}_{ijkol} ) = 1 - p ( {r}_{ijkol} = 1 \vert {θ}_{ijk} , {f}_{ijko} , {c}_{ijkol} ) . \qquad ( 37 b )$$

where rᵢⱼₖₒₗ and cᵢⱼₖₒₗ are the response and contrast of the l^{th} (=1, 2, 3) optotype in row 0; fᵢⱼₖₒ is the nominal spatial frequency for row o; γ=0.1 (guessing rate for 10 letters); η=0.04 (lapse rate); (is the cumulative Gaussian; and ω controls steepness. The non-parametric CSF model is therefore defined by 6 parameters×24 time points=144 latent variables per subject.

A four-layer pyramid [symbol] _{θ} was defined: B₀=3, B₁=6, B₂=12, B₃=24. Priors for BIP, HBMv and HBMc models in [symbol] _{θ} and [symbol] _{δ} are detailed in Table 13. HBMc priors were set only at the top layer due to ill-defined covariance at lower layers of [symbol] _{θ} for I=36.

TABLE 13
Exemplary Priors in Test 4.

| | | |
|---|---|---|
| [symbol] _{θ} | BIP | ${p}_{0} ( {θ}_{{ijb}_{l}}^{f} ) = U ( lb , ub ) , lb = - 3. , ub = 0.5 , i ϵ [ 1 , 36 ] , j = 1 , {b}_{l} ϵ [ 1 , {B}_{l} ] l ϵ [ 0 , 3 ]$ |
| | | p₀(ω) = U(lb, ub), lb = 1, ub = 3 |
| | HBMv | ${p}_{0} ( {μ}_{{b}_{l}}^{f} ) = U ( lb , ub ) , lb = - 3. , ub = 0.5 , {b}_{l} ϵ [ 1 , {B}_{l} ] , l ϵ [ 0 , 3 ]$ ${p}_{0} ( {σ}_{{b}_{l}}^{f} ) = Γ ( {α}_{pop} , {β}_{pop} ) , {p}_{0} ( {ε}_{{b}_{l}}^{f} ) = Γ ( {α}_{ind} , {β}_{ind} ) , {α}_{pop} = 2. , {α}_{ind} = 2. , {β}_{pop} = 10 , {β}_{ind} = 10$ p₀(κ) = U(lb, ub), lb = 1, ub = 3 |
| | HBMc | p₀(μ^{f}) = U^{(6B}₀⁾ (lb, ub), lb = - 3.0, ub = 0.5 |
| | | p₀(sd_dist0) = ε(λ₀, 6B₀), p₀(Σ) = LKJCov(v₀, sd_dist0, 6B₀), λ₀ = 5.0, v₀ = 2.0 |
| | | p₀(sd_dist1) = ε(λ₁, 6), p₀(Σ′) = LKJCov(v₁, sd_dist1, 6), λ₁ = 5.0, v₁ = 2.0 |
| | | p₀(κ) = U(lb, ub), lb = 1, ub = 3 |
| [symbol] _{δ} | BIP | ${p}_{0} ( {δθ}_{{ijb}_{l}}^{f} ) = U ( δ {lb}_{l} , δ {ub}_{l} ) , i ϵ [ 1 , 36 ] , j = 1 , {b}_{l} ϵ [ 1 , {B}_{l} ] l ϵ [ 0 , 2 ]$ |
| | | δlbₗ = − 0.15, δubₗ = 0.15; |
| | HBMv | ${p}_{0} ( {δμ}_{{b}_{l}}^{f} ) = U ( δ {lb}_{l} , δ {ub}_{l} ) , {b}_{l} ϵ [ 1 , {B}_{l} ] , l ϵ [ 0 , 2 ]$ |
| | | δlbₗ = − 0.15, δubₗ = 0.15 |
| | | p₀(δσ_{b}_{ₗ}) = Γ(δαₚₒₚ,ₗ, δβ_{pop,l}), p₀(δε_{b}_{ₗ}) = Γ(δα_{ind,l}, δβ_{ind,l}) |
| | | δα_{pop,l} = 2.0, δα_{ind,l} = 2.0, δβ_{pop,l} = 10, δβ_{ind,l} =10 |

Exemplary Results: The results of this exemplary validation test can demonstrate the three core claims of the framework on longitudinal contrast sensitivity functions using B blocks and I subjects, where θ represents the subject-level latent parameter and Δy (or δ) the difference parameters (see Table 2): the pyramid structure dramatically reduces computational cost (scalability), HBMc-HBMv reliably recovers the CSF trajectory under sparse sampling conditions (precision under sparsity; main analyses used up to 24 time points/visits with 1 visit per block), and the multi-resolution layers provide complementary information that improves interpretability of coarse trends versus fine details.

Table 14 presents the results from pairwise model comparisons. HBMc-HBMv dominated with WAIC weights of 1.0 in all pairwise comparisons, making it the top-performing model. HBMv-HBMv followed closely, achieving weights of 1.0 in most comparisons, except against BIP-HBMv (0.9499) and HBMc-HBMv (0.0). BIP-HBMv also performed strongly, with weights of 1.0 against most models, but had a weight of 0.0501 against HBMv-HBMv. HBMc-BIP and HBMv-BIP outperformed simpler models (BIP-BIP, HBMv, BIP) but were less preferred than HBMc-HBMv, HBMv-HBMv, and BIP-HBMv. BIP-BIP and HBMv only surpassed BIP, with weights of 0.0 in most other comparisons, while BIP was the least preferred, with a weight of 0.0 in all matchups.

TABLE 14
Exemplary Model Weights in Test 4.

| | | | BIP- | BIP- | HBMv- | HBMv- | HBMc- | HBMc- |
|---|---|---|---|---|---|---|---|---|
| Model | BIP | HBMv | BIP | HBMv | BIP | HBMv | BIP | HBMv |
| BIP | — | 0.0 | 0.0 | 0.0 | 0.0 | 0.0 | 0.0 | 0.0 |
| HBMv | 1.0 | — | 0.0 | 0.0 | 0.0 | 0.0 | 0.0 | — |
| BIP-BIP | 1.0 | 1.0 | — | 0.0 | 0.0 | 0.0 | 0.0 | 0.0 |
| BIP-HBMv | 1.0 | 1.0 | 1.0 | — | 1.0 | 0.0501 | 1.0 | 0.0 |
| HBMv-BIP | 1.0 | 1.0 | 1.0 | 0.0 | — | 0.0 | 0.0 | 0.0 |
| HBMv- | 1.0 | 1.0 | 1.0 | 0.9499 | 1.0 | — | 1.0 | 0.0 |
| HBMv | | | | | | | | |
| HBMc-BIP | 1.0 | 1.0 | 1.0 | 0.0 | 1.0 | 0.0 | — | 0.0 |
| HBMc-HBMv | 1.0 | — | 1.0 | 1.0 | 1.0 | 1.0 | 1.0 | — |

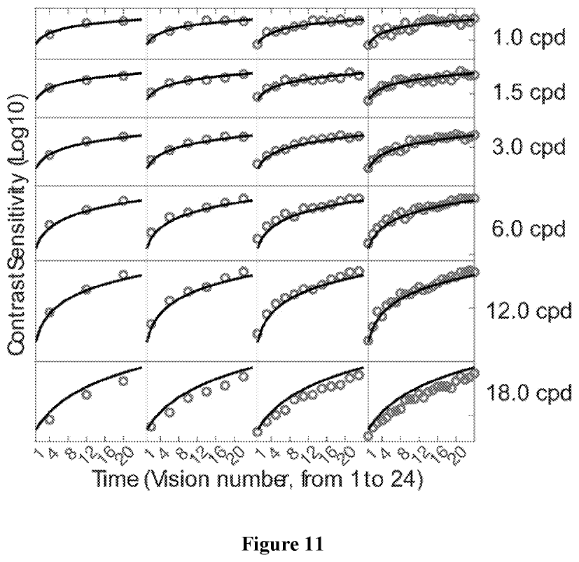

FIG. 11 illustrates an exemplary set of graphs where each row represents an average CS at each of the six FDA-designated spatial frequencies, and where column 1 represents the “truth” and columns 2 through 5 represent an average CS at each of the four layers according to an exemplary embodiment of the present disclosure The x-axis shows time (visit number from 1 to 24). Black lines show the true (simulated) values; magenta points show posterior mean reconstructions from the models. FIG. 11 is provided to demonstrate progressive refinement of longitudinal CSFs across time and pyramid layers.

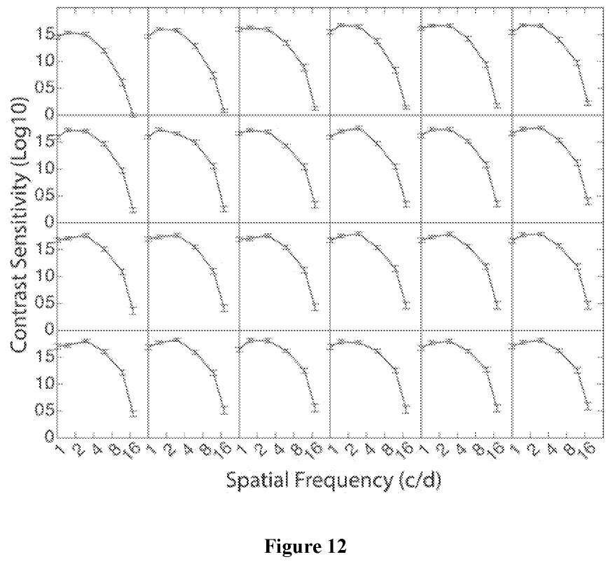

FIG. 12 illustrates an exemplary set of graphs showing mean estimated contrast sensitivity functions (CSFs) from the HBMc-HBMv model across 36 subjects at 24 time points, with time progressing from 1-6 (row 1), 7-12 (row 2), 13-18 (row 3), to 19-24 (row 4) according to an exemplary embodiment of the present disclosure.

Specifically, FIG. 11 presents the average CS at each of the six FDA-designated spatial frequencies in the four layers of the pyramid. FIG. 12 presents the mean estimated contrast sensitivity functions (CSFs) from the HBMc-HBMv model across 36 subjects at 24 time points.

As shown in FIG. 11, the exemplary systems, methods, and computer accessible medium according to the exemplary embodiments of the present disclosure can illustrate average contrast sensitivity at each of six FDA-designated spatial frequencies across four pyramid layers in a longitudinal validation test. FIG. 11 can be organized with each row representing a different spatial frequency, labeled from top to bottom as 1.0 cpd, 1.5 cpd, 3.0 cpd, 6.0 cpd, 12.0 cpd, and 18.0 cpd. The vertical axis can represent contrast sensitivity measured in log base 10 units, and the horizontal axis can represent time expressed as visit number from 1 to 24. Each row can display data across four columns corresponding to the four layers of the parameter pyramid. First lines can show the true simulated values of contrast sensitivity over time, while markers can show posterior mean reconstructions from the models. The graphs can demonstrate progressive refinement of longitudinal contrast sensitivity functions across time and pyramid layers, with the model reconstructions closely tracking the true values. At lower spatial frequencies such as 1.0 cpd and 1.5 cpd, the contrast sensitivity values can be higher and can show relatively stable trajectories over time. At higher spatial frequencies such as 12.0 cpd and 18.0 cpd, the contrast sensitivity values can be lower and can exhibit more pronounced changes across the time course.

As shown in FIG. 12, the exemplary systems, methods, and computer accessible medium according to the exemplary embodiments of the present disclosure can illustrate mean estimated contrast sensitivity functions from the HBMc-HBMv model across 36 subjects at 24 time points. FIG. 12 is illustrated as a grid with four rows and six columns, where each row can represent a different time progression range and each column can correspond to a different time point within that range. A first row can display time points 1 through 6, a second row can display time points 7 through 12, a third row can display time points 13 through 18, and a fourth row can display time points 19 through 24. The vertical axis can represent contrast sensitivity measured in log base 10 units, and the horizontal axis can represent spatial frequency measured in cycles per degree on a logarithmic scale. Each individual panel can contain a curve showing the contrast sensitivity function at a specific time point, with data points connected by lines and error bars indicating 95 percent credible intervals. The curves can exhibit a characteristic bandpass shape, with peak sensitivity occurring at intermediate spatial frequencies and reduced sensitivity at both low and high spatial frequencies. FIG. 12 illustrates the exemplary final high-resolution contrast sensitivity function estimates obtained through the hierarchical Bayesian modeling approach of the exemplary systems, methods, and computer accessible medium according to the exemplary embodiments of the present disclosure.

The average exemplary RMSE and standard deviations across all six spatial frequencies are presented in Table 13. HBMc-HBMv achieved the best RMSE, ranging from e.g., 0.0596 at Layer 0 to e.g., 0.0917 at Layer 3, and the lowest SD, from e.g., 0.0212 to 0.0707, demonstrating superior accuracy and precision. HBMv-HBMv followed closely, with RMSE from e.g., 0.0613 to 0.0927 and SD from e.g., 0.0220 to 0.0709. Other pyramid models (BIP-BIP, BIP-HBMv, HBMv-BIP, HBMc-BIP) showed intermediate RMSE (e.g., BIP-BIP: 0.0640-0.1086) and SD (e.g., BIP-HBMv: 0.0228-0.0712), while HBMv had RMSE from e.g., 0.0616 to 0.1037 but higher SD (e.g., 0.0418-0.1004). BIP performed the worst, with the highest RMSE, increasing from e.g., 0.0661 to 0.3370, and SD, rising from e.g., 0.0468 to 0.2598, indicating poor accuracy and high variability. Both RMSE and SD increased with layer resolution for all models, but hierarchical models consistently outperformed simpler ones like BIP.

For example, HBMc-HBMv reduced SD by e.g., 64.5%, compared to BIP. The largest reductions occur at Layer 3 (e.g., 72.8%), underscoring its precision in high-resolution, sparse data. HBMc-HBMv reduced RMSE by e.g., 46.5%. The reduction grew with resolution, peaking at Layer 3 (e.g., 72.8%), reflecting improved accuracy as data complexity increases. HBMc-HBMv consistently outperformed HBMv-HBMv in both SD and RMSE, with the covariance enhancement providing a modest but notable benefit, especially at lower layers (e.g., Layer 0: 9.8% vs. 7.3% RMSE reduction). This suggests HBMc-HBMv better captured interdependencies in the longitudinal CSF dataset, though the difference diminished at higher layers due to data sparsity.

TABLE 15
Exemplary RMSE and Standard Deviations in Test 4.

| | RMSE | | | | SD | | | |
|---|---|---|---|---|---|---|---|---|
| | Layer 0 | Layer 1 | Layer 2 | Layer 3 | Layer 0 | Layer 1 | Layer 2 | Layer 3 |
| BIP | 0.0661 | 0.1183 | 0.2213 | 0.3370 | 0.0468 | 0.0816 | 0.1438 | 0.2598 |
| HBMv | 0.0616 | 0.0711 | 0.0865 | 0.1037 | 0.0418 | 0.0563 | 0.0751 | 0.1004 |
| BIP-BIP | 0.0640 | 0.0792 | 0.0971 | 0.1086 | 0.0229 | 0.0341 | 0.0536 | 0.0848 |
| BIP-HBMv | 0.0629 | 0.0729 | 0.0853 | 0.0938 | 0.0228 | 0.0315 | 0.0470 | 0.0712 |
| HBMv-BIP | 0.0622 | 0.0776 | 0.0959 | 0.1074 | 0.0221 | 0.0335 | 0.0532 | 0.0845 |
| HBMv-HBMv | 0.0613 | 0.0715 | 0.0841 | 0.0927 | 0.0220 | 0.0309 | 0.0466 | 0.0709 |
| HBMc-BIP | 0.0605 | 0.0762 | 0.0947 | 0.1064 | 0.0214 | 0.0330 | 0.0529 | 0.0843 |
| HBMc-HBMv | 0.0596 | 0.0701 | 0.0830 | 0.0917 | 0.0212 | 0.0304 | 0.0462 | 0.0707 |

### EXEMPLARY DISCUSSION

The exemplary embodiments of the present disclosure provide an exemplary pyramid-based multi-resolution Bayesian framework to estimate high-resolution latent variables in generative models of human behavior, addressing the limitations of aggregated data in capturing fine-grained dynamics across domains like education, perceptual learning, and clinical vision, where sparse data and large covariance matrices challenge traditional hierarchical models like HBMc. It constructs a parameter pyramid with a top-layer HBM incorporating covariance for coarse trends, iteratively refining estimates at finer resolutions using a difference pyramid, implemented in PyMC for scalability. Tested across four experiments with eight models (BIP, HBMv, and six pyramid variants) on datasets including 36 Gaussian time series, perceptual learning from 49 subjects, 36 perimetry sets, and 24 CSF measurements from 36 subjects, the HBMc-HBMv model consistently outperformed simpler models like BIP, achieving the lowest RMSE (e.g., 0.0330-0.1115) and SD (e.g., 0.0212-0.0941), reducing errors by up to 74.1% and variability by up to 78.5%. This approach excels in capturing fine-grained dynamics, making it highly effective for applications requiring precise, high-resolution analysis of sparse data.

The exemplary pyramid-based method provides a hierarchical multi-resolution framework for estimating high-resolution latent variables from sparse behavioral data, utilizing a parameter pyramid ( [symbol] _{θ}) for coarse trends and a difference pyramid ( [symbol] _{δ}) for iterative refinement, with formal proofs for 1D and 2D cases. It employs a Bayesian framework with three estimation variants—BIP (independent parameters), HBMv (variance only), and HBMc (with covariance)—where HBMc enhances precision by hierarchically pooling population and individual data, improving scalability for large datasets like perceptual learning or visual field maps. Implemented in PyMC with variational inference, the method avoids the computational burden of large covariance matrices, offering an interpretable and scalable solution validated across domains like education and finance.

Compared with the standard independent-parameter approach (BIP) used in the majority of psychophysical studies, the pyramid framework (with covariance restricted to the top layer of B₀ blocks) consistently delivered lower RMSE and SD across all four datasets while using far less computation (see Table 2). BIP suffered from high variance and poor recovery under sparsity; HBMc-HBMv matched or exceeded the accuracy of more complex full-covariance alternatives while remaining stable and scalable even in the extreme-sparsity regime demonstrated in the Illustrative Example section. These explicit comparisons confirm that restricting covariance to the coarsest layer is both computationally advantageous and statistically beneficial for high-resolution behavioral functions.

An exemplary alternative reparameterization using a polynomial basis within each coarse block (constant+linear term) can also be evaluated in the illustrative example. It can remove the power-of-two block-size requirement but performs less robustly when fine-scale correlations are present (higher RMSE in the violating case). The difference-pyramid approach therefore can retain better locality and scalability for the behavioral applications targeted here.

The exemplary pyramid method mirrors wavelet analysis (see, e.g., Ref. 103) in its hierarchical, multi-resolution approach, as both decompose data into coarse and fine scales— [symbol] _{θ} and [symbol] _{δ} in the pyramid method, and approximations and details in wavelet analysis—assuming smoothness to reveal patterns across resolutions, making them effective for sparse or noisy data in domains like time series or spatial analysis. However, the pyramid method infers latent variables in discrete behavioral data using Bayesian inference with uncertainty quantification, tailored to specific block sizes for generative modeling, while wavelet analysis deterministically decomposes signals into time-frequency components for representation, using filter banks that suit continuous or irregularly sampled data in engineering applications like signal processing, prioritizing feature extraction over behavioral interpretability.

The pyramid method shares Bayesian inference principles with Gaussian process (GP) (see, e.g., Ref. 116) and sparse GP (SGP) (see, e.g., Refs. 84, 102) modeling to estimate smooth latent variables from sparse, noisy data. Both approaches capture multi-scale patterns-explicitly through the pyramid's layered structure, and implicitly via the covariance kernel (e.g., squared exponential) in GPs and SGPs—suiting them for tasks like time series or spatial modeling. However, GPs model continuous latent functions with a single covariance structure, incurring O(B³) complexity (where B is the number of blocks) that becomes computationally intensive for large datasets, while SGPs reduce this to O(B P²) (where P is the number of inducing points, typically P«B) using inducing points to approximate the full GP, excelling in irregularly sampled continuous domains but still requiring significant resources. The exemplary pyramid method, by contrast, decomposes the problem into discrete layers, estimating coarse trends first and refining them iteratively, which lowers computational cost, enhances interpretability by explicitly separating scales, and stabilizes estimates for structured behavioral data with sparse observations, though it lacks the flexibility of GPs/SGPs for continuous, unstructured domains where kernel-based methods can more easily adapt to varying data densities. The pyramid method and GP are, however, not mutually exclusive. A separate difference pyramid for each top-layer entry in terms of GP can potentially combine the strengths of both approaches for enhanced flexibility and precision.

Such exemplary embodiments of the present disclosure can provide primarily utilized simple generative functions to model behavioral data within the pyramid framework, ensuring computational efficiency and interpretability. However, the method could be extended to incorporate more complex generative functions, which would allow for modeling richer behavioral phenomena, such as non-linear interactions or dynamic dependencies, potentially improving its applicability to more intricate tasks in perception or other domains while maintaining its hierarchical, multi-resolution structure.

While the exemplary embodiments of the present disclosure focused on perception, the exemplary pyramid method's ability to capture detailed temporal dynamics and spatial characteristics of latent variables makes it applicable to diverse fields like learning and memory, human factors, education, clinical trials, healthcare, financial analysis, and decision-making, where understanding human performance requires high-resolution estimates. In these fields, the stochastic nature of human behavior often leads to empirical inference from aggregated data across many time points or spatial regions, limiting resolution, but the exemplary systems, methods, and computer accessible medium according to the exemplary embodiments of the present disclosure can provide a mathematical framework and estimation procedures that enable high spatial/temporal resolution estimates from behavioral measurements, offering a versatile tool for deeper insights into human performance across these domains.

The exemplary pyramid-based method provides a significant advancement in estimating high-resolution latent variables from sparse behavioral data, combining a novel multi-resolution framework with Bayesian inference to outperform traditional approaches like wavelet analysis and GP/SGP in structured, discrete domains, while offering scalability and interpretability. Its potential to adopt more complex generative functions and its applicability across diverse fields—from education to financial analysis—highlight its versatility in addressing the challenges of stochastic human behavior, paving the way for more precise and insightful analyses of human performance in both research and applied settings.

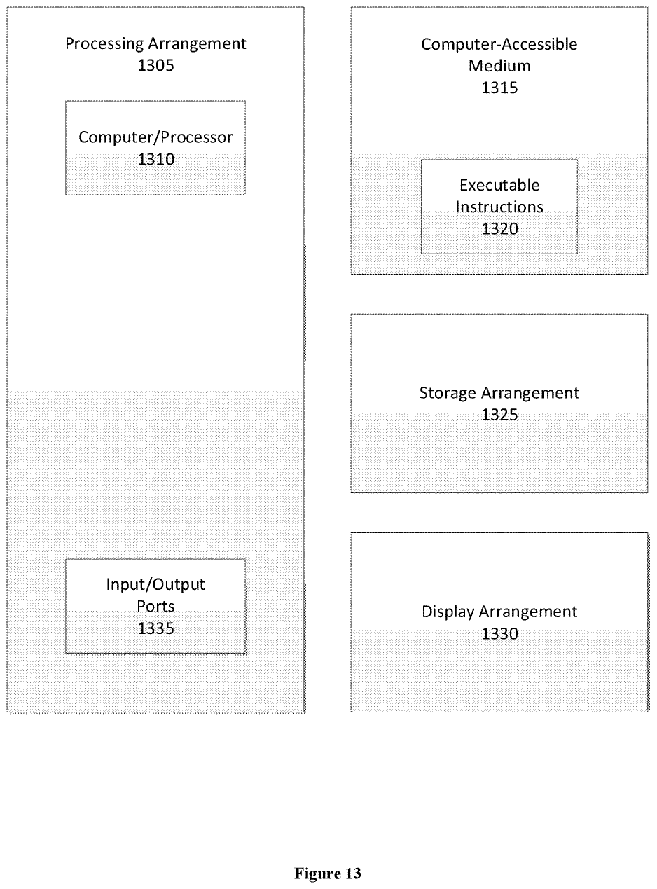

FIG. 13 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 1305. Such processing/computing arrangement 1305 can be, for example entirely or a part of, or include, but not limited to, a computer/processor 1310 that can include, for example, one or more microprocessors, and use instructions stored on a computer-accessible medium (e.g., RAM, ROM, hard drive, or other storage device).

As shown in FIG. 13, for example a computer-accessible medium 1315 (e.g., as described herein above, a storage device such as a hard disk, floppy disk, memory stick, CD-ROM, RAM, ROM, etc., or a collection thereof) can be provided (e.g., in communication with the processing arrangement 1305). The computer-accessible medium 1315 can contain executable instructions 1320 thereon. In addition, or alternatively, a storage arrangement 1325 can be provided separately from the computer-accessible medium 1315, which can provide the instructions to the processing arrangement 1305 so as to configure the processing arrangement to execute certain exemplary procedures, processes, and methods, as described herein above, for example. Further, the exemplary processing arrangement 1305 can be provided with or include an input/output ports 1335, which can include, for example, a wired network, a wireless network, the internet, an intranet, a data collection probe, a sensor, etc. As shown in FIG. 13, the exemplary processing arrangement 1305 can be in communication with an exemplary display arrangement 1330, which, according to certain exemplary embodiments of the present disclosure, can be a touch-screen configured for inputting information to the processing arrangement in addition to outputting information from the processing arrangement, for example. Further, the exemplary display arrangement 1330 and/or a storage arrangement 1325 can be used to display and/or store data in a user-accessible format and/or user-readable format.

According to the exemplary embodiments of the present disclosure, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the appended claims, and may include other examples that occur to those skilled in the art. Such other examples are intended to be within the scope of the appended claims if they have structural elements that do not differ from the literal language of the appended claims, or if they include equivalent structural elements with insubstantial differences from the literal language of the appended claims.

### EXEMPLARY REFERENCES

The following references are hereby incorporated by reference, in their entireties:
1. Alahmadi, B. O., Omari, A. A., Abalem, M. F., Andrews, C., Schlegel, D., Branham, K. H., . . . Jayasundera, T. (2018). Contrast sensitivity deficits in patients with mutation-proven inherited retinal degenerations. BMC ophthalmology, 18, 1-6.
2. Anders, P., Traber, G. L., Hall, U., Garobbio, S. A., Chan, E. J., Gabrani, C., . . . Scholl, H. P. (2023). Evaluating Contrast Sensitivity in Early and Intermediate Age-Related Macular Degeneration With the Quick Contrast Sensitivity Function. Investigative ophthalmology & visual science, 64(14), 7-7.
3. Anderson, D. R. (1999). Automated static perimetry. (No Title), 152.
4. Ardizzone, E., Gaglio, S., & Sorbello, F. (1989). Geometric and conceptual knowledge representation within a generative model of visual perception. Journal of Intelligent and Robotic Systems, 2, 381-409.
5. Baker, R. S., D'Mello, S. K., Rodrigo, M. M. T., & Graesser, A. C. (2010). Better to be frustrated than bored: The incidence, persistence, and impact of learners' cognitive-affective states during interactions with three different computer-based learning environments. International Journal of Human-Computer Studies, 68(4), 223-241.
6. Baldwin, G., Vingopoulos, F., Zeng, R., Wescott, H., Bannerman, A., Koch, T., . . . Kim, L. A. (2023). Association between contrast sensitivity and central Subfield thickness in center-involving diabetic macular edema. Journal of VitreoRetinal Diseases, 7(3), 232-238.
7. Ball, K., & Sekuler, R. (1982). A specific and enduring improvement in visual motion discrimination. Science, 218(4573), 697-698.
8. Bang, J. W., Shibata, K., Frank, S. M., Walsh, E. G., Greenlee, M. W., Watanabe, T., & Sasaki, Y. (2018). Consolidation and reconsolidation share behavioural and neurochemical mechanisms. Nature Human Behaviour, 2(7), 507-513.
9. Beard, B. L., Levi, D. M., & Reich, L. N. (1995). Perceptual learning in parafoveal vision. Vision research, 35(12), 1679-1690.
10. Bengtsson, B., Heijl, A., & Agardh, E. (2005). Visual fields correlate better than visual acuity to severity of diabetic retinopathy. Diabetologia, 48, 2494-2500.
11. Brown, B. (1981). Reading performance in low vision patients: relation to contrast and contrast sensitivity. Optometry and Vision Science, 58(3), 218-226.
12. Brown, S., & Heathcote, A. (2003). Averaging learning curves across and within participants. Behavior Research Methods, Instruments, & Computers, 35, 11-21.
13. Caprioli, J. (1991). Automated perimetry in glaucoma. American journal of ophthalmology, 111(2), 235-239.
14. Cen, H., Koedinger, K., & Junker, B. (2008). Comparing two IRT models for conjunctive skills. Paper presented at the Intelligent Tutoring Systems: 9th International Conference, ITS 2008, Montreal, Canada, Jun. 23-27, 2008 Proceedings 9.
15. Censor, N., Karni, A., & Sagi, D. (2006). A link between perceptual learning, adaptation and sleep. Vision research, 46(23), 4071-4074.
16. Cochrane, A., Lu, Z.-L., & Green, C. S. (2024). Modeling Perceptual Learning as a Continuous Function of Time-on-Task Increases Theoretical Specificity and Statistical Power. Journal of Cognitive Enhancement, 8(4), 294-307. doi:10.1007/s41465-024-00303-3
17. Comford, J. P. (1983). Vision evaluation using contrast sensitivity functions. Optometry and Vision Science, 60(5), 394-398.
18. Corbett, A. T., & Anderson, J. R. (1994). Knowledge tracing: Modeling the acquisition of procedural knowledge. User modeling and user-adapted interaction, 4, 253-278.
19. Cornsweet, T. (2012). Visual perception: Academic press.
20. Crossman, E. R. (1959). A theory of the acquisition of speed-skill*. Ergonomics, 2(2), 153-166.
21. Csaky, K., Ferris, F., Chew, E. Y., Nair, P., Cheetham, J. K., & Duncan, J. L. (2017). Report from the NEI/FDA endpoints workshop on age-related macular degeneration and inherited retinal diseases. Investigative ophthalmology & visual science, 58(9), 3456-3463.
22. Csaky, K. G., Richman, E. A., & Ferris, F. L. (2008). Report from the NEI/FDA ophthalmic clinical trial design and endpoints symposium. Investigative ophthalmology & visual science, 49(2), 479-489.
23. Cusimano, M., Hewitt, L. B., & McDermott, J. H. (2024). Listening with generative models. Cognition, 253, 105874.
24. D'Mello, S., & Graesser, A. (2012). Dynamics of affective states during complex learning. Learning and Instruction, 22(2), 145-157.
25. Dale, G., Cochrane, A., & Green, C. S. (2021). Individual difference predictors of learning and generalization in perceptual learning. Attention, Perception, & Psychophysics, 1-15.
26. Dayan, P., & Daw, N. D. (2008). Decision theory, reinforcement learning, and the brain. Cognitive, Affective, & Behavioral Neuroscience, 8(4), 429-453.
27. DeValois, R. L., & DeValois, K. K. (1990). Spatial vision.
28. Dixon, W. J., & Mood, A. M. (1948). A method for obtaining and analyzing sensitivity data. Journal of the American Statistical Association, 43(241), 109-126.
29. Donovan, I., Szpiro, S., & Carrasco, M. (2015). Exogenous attention facilitates location transfer of perceptual learning. Journal of vision, 15(10), 11-11.
30. Dorr, M., Kwon, M., Lesmes, L. A., Miller, A., Kazlas, M., Chan, K., . . . Bex, P. J. (2019). Binocular summation and suppression of contrast sensitivity in strabismus, fusion and amblyopia. Frontiers in human neuroscience, 13, 234.
31. Dosher, B. A., Liu, J., Chu, W., & Lu, Z.-L. (2020). Roving: The causes of interference and re-enabled learning in multi-task visual training. Journal of vision, 20(6), 9-9.
32. Dosher, B. A., & Lu, Z.-L. (2020). Perceptual Learning: How Experience Shapes Visual Perception. Cambridge, MA: MIT Press.
33. Dosher, B. A., & Lu, Z. L. (1998). Perceptual learning reflects external noise filtering and internal noise reduction through channel reweighting. Proc. Natl Acad. Sci. USA, 95. doi:10.1073/pnas.95.23.13988
34. Fahle, M., Edelman, S., & Poggio, T. (1995). Fast perceptual learning in hyperacuity. Vision research, 35(21), 3003-3013.
35. Flanagan, J. G., Wild, J. M., & Trope, G. E. (1993). Evaluation of FASTPAC, a new strategy for threshold estimation with the Humphrey Field Analyzer, in a glaucomatous population. Ophthalmology, 100(6), 949-954.
36. Fleming, R. W. (2014). Visual perception of materials and their properties. Vision research, 94, 62-75.
37. Freeman, E. E., Munoz, B., Turano, K. A., & West, S. K. (2005). Measures of visual function and time to driving cessation in older adults. Optometry and Vision Science, 82(8), 765-773.
38. Gallistel, C. R., Fairhurst, S., & Balsam, P. (2004). The learning curve: implications of a quantitative analysis. Proceedings of the National Academy of Sciences,
101(36), 13124-13131.
39. Gao, H., Miles, T. P., Troche, R., Murdoch, D. M., Koefoed, V. F., & Cason, J. B. (2022). Quality of vision following LASIK and PRK-MMC for treatment of myopia. Military Medicine, 187(9-10), e1051-e1058.
40. Gelman, A., Hwang, J., & Vehtari, A. (2014). Understanding predictive information criteria for Bayesian models. Statistics and computing, 24, 997-1016.
41. Ginsburg, A. P. (2003). Contrast sensitivity and functional vision. International ophthalmology clinics, 43(2), 5-15.
42. Gomez-Villa, A., Martin, A., Vazquez-Corral, J., Bertalmio, M., & Malo, J. (2022). On the synthesis of visual illusions using deep generative models. Journal of vision, 22(8), 2-2.
43. Graham, N. V. S. (1989). Visual pattern analyzers: Oxford University Press.
44. Green, C. S., Banai, K., Lu, Z. L., & Bavelier, D. (2018). Perceptual learning. Stevens' Handbook of Experimental Psychology and Cognitive Neuroscience, 2, 1-47.
45. Guo, D., Meng, J., Zhang, K., He, W., Ma, S., Lu, Z.-1., . . . Zhu, X. (2022). Tolerance to lens tilt and decentration of two multifocal intraocular lenses: using the quick contrast sensitivity function method. Eye and Vision, 9(1), 45.
46. Haley, M. J. (1986). The field analyzer primer: Allergan Humphrey.
47. Heijl, A. (1985). The Humphrey field analyzer, construction and concepts. Paper presented at the Sixth International Visual Field Symposium: Santa Margherita Ligure, May 27-31, 1984.
48. Heijl, A., Lindgren, A., & Lindgren, G. (1989). Test-retest variability in glaucomatous visual fields. American journal of ophthalmology, 108(2), 130-135.
49. Heijl, A., Lindgren, G., & Olsson, J. (1987). Normal variability of static perimetric threshold values across the central visual field. Archives of ophthalmology, 105(11), 1544-1549.
50. Hou, F., Huang, C.-B., Lesmes, L., Feng, L.-X., Tao, L., Zhou, Y.-F., & Lu, Z.-L. (2010). qCSF in clinical application: efficient characterization and classification of contrast sensitivity functions in amblyopia. Investigative ophthalmology & visual science, 51(10), 5365-5377.
51. Hou, F., Lesmes, L., Bex, P., Dorr, M., & Lu, Z.-L. (2015). Using 10AFC to further improve the efficiency of the quick CSF method. Journal of vision, 15(9), 2-2.
52. Hou, F., Lesmes, L. A., Kim, W., Gu, H., Pitt, M. A., Myung, J. I., & Lu, Z.-L. (2016). Evaluating the performance of the quick CSF method in detecting contrast sensitivity function changes. Journal of vision, 16(6), 18-18.
53. Jindra, L. F., & Zemon, V. (1989). Contrast sensitivity testing: a more complete assessment of vision. Journal of Cataract & Refractive Surgery, 15(2), 141-148.
54. Johnson, C. A., Chauhan, B., & Shapiro, L. (1992). Properties of staircase procedures for estimating thresholds in automated perimetry. Investigative ophthalmology & visual science, 33(10), 2966-2974.
55. Joltikov, K. A., de Castro, V. M., Davila, J. R., Anand, R., Khan, S. M., Farbman, N., . . . Gardner, T. W. (2017). Multidimensional functional and structural evaluation reveals neuroretinal impairment in early diabetic retinopathy. Investigative ophthalmology & visual science, 58(6), B10277-B10290.
56. Karni, A., & Sagi, D. (1991). Where practice makes perfect in texture discrimination: evidence for primary visual cortex plasticity. Proceedings of the National Academy of Sciences, 88(11), 4966-4970.
57. Karni, A., Tanne, D., Rubenstein, B. S., Askenasy, J. J., & Sagi, D. (1994). Dependence on REM sleep of overnight improvement of a perceptual skill. Science, 265(5172), 679-682.
58. Katz, J., & Sommer, A. (1987). A longitudinal study of the age-adjusted variability of automated visual fields. Archives of ophthalmology, 105(8), 1083-1086.
59. Keltner, J. L., Johnson, C. A., Quigg, J. M., Cello, K. E., Kass, M. A., Gordon, M. O., & Group, 0. H. T. S. (2000). Confirmation of visual field abnormalities in the Ocular Hypertension Treatment Study. Archives of ophthalmology, 118(9), 1187-1194.
60. Kersten, D. (2002). Object perception: Generative image models and Bayesian inference. Paper presented at the International Workshop on Biologically Motivated Computer Vision.
61. Kirschner, P. A., Sweller, J., & Clark, R. E. (2006). Why minimal guidance during instruction does not work: An analysis of the failure of constructivist, discovery, problem-based, experiential, and inquiry-based teaching. Educational psychologist, 41(2), 75-86.
62. Koedinger, K. R., Corbett, A. T., & Perfetti, C. (2012). The Knowledge-Learning-Instruction framework: Bridging the science-practice chasm to enhance robust student learning. Cognitive Science, 36(5), 757-798.
63. Kruschke, J. (2014). Doing Bayesian data analysis: A tutorial with R, JAGS, and Stan.
64. Lesmes, L. A., Lu, Z.-L., Baek, J., & Albright, T. D. (2010). Bayesian adaptive estimation of the contrast sensitivity function: The quick CSF method. Journal of vision, 10(3), 17-17.
65. Lewis, R. A., Johnson, C. A., Keltner, J. L., & Labermeier, P. K. (1986). Variability of quantitative automated perimetry in normal observers. Ophthalmology, 93(7), 878-881.
66. Liu, X., Wang, Y., Ying, X., Zhang, F., Huang, J., Yu, H., . . . Lesmes, L. (2022). Contrast sensitivity is associated with chorioretinal thickness and vascular density of eyes in simple early-stage high myopia. Frontiers in Medicine, 9, 847817.
67. Lu, Z.-L., & Dosher, B. A. (2008). Characterizing observers using external noise and observer models: assessing internal representations with external noise. Psychological review, 115(1), 44-82.
68. Lu, Z.-L., & Dosher, B. A. (2013). Visual psychophysics: From laboratory to theory: MIT Press.
69. Lu, Z.-L., & Dosher, B. A. (2022). Current directions in visual perceptual learning. Nature Reviews Psychology, 1(11), 654-668. doi:10.1038/s44159-022-00107-2
70. Lu, Z.-L., Zhao, Y., Lesmes, L. A., & Dorr, M. (2024). Quantifying the functional relationship between visual acuity and contrast sensitivity function. Investigative ophthalmology & visual science, 65(12), 33-33.
71. Marron, J. A., & Bailey, I. L. (1982). Visual factors and orientation-mobility performance. Optometry and Vision Science, 59(5), 413-426.
72. Mascetti, L., Muto, V., Matarazzo, L., Foret, A., Ziegler, E., Albouy, G., . . . Leclercq, Y. (2013). The impact of visual perceptual learning on sleep and local slow-wave initiation. Journal of Neuroscience, 33(8), 3323-3331.
73. McDevitt, E. A., Rokem, A., Silver, M. A., & Mednick, S. C. (2014). Sex differences in sleep-dependent perceptual learning. Vision research, 99, 172-179.
74. Meng, J., Song, Y., He, W., Lu, Z.-L., Chen, Y., Wei, L., . . . Lu, Y. (2024). A novel artificial intelligence-based classification of highly myopic eyes based on visual function and fundus features. Translational Vision Science & Technology, 13(9), 12-12.
75. Montague, P. R., & Sejnowski, T. J. (1994). The predictive brain: temporal coincidence and temporal order in synaptic learning mechanisms. Learning & Memory, 1(1), 1-33.
76. Newell, A., & Rosenbloom, P. S. (2013). Mechanisms of skill acquisition and the law of practice. In Cognitive skills and their acquisition (pp. 1-55): Psychology Press.
77. Ng, M., Sample, P. A., Pascual, J. P., Zangwill, L. M., Girkin, C. A., Liebmann, J. M., . . . Racette, L. (2012). Comparison of visual field severity classification systems for glaucoma. Journal of glaucoma, 21(8), 551-561.
78. Ou, W. C., Lesmes, L. A., Christie, A. H., Denlar, R. A., & Csaky, K. G. (2021). Normal- and low-luminance automated quantitative contrast sensitivity assessment in eyes with age-related macular degeneration. American journal of ophthalmology, 226, 148-155.
79. Owsley, C., & McGwin Jr, G. (2010). Vision and driving. Vision research, 50(23), 2348-2361.
80. Pang, R., Peng, J., Cao, K., Sun, Y., Pei, X.-T., Yang, D., . . . Wang, N. (2024). Association between contrast sensitivity function and structural damage in primary open-angle glaucoma. British Journal of Ophthalmology, 108(6), 801-806.
81. Parr, T., Sajid, N., Da Costa, L., Mirza, M. B., & Friston, K. J. (2021). Generative models for active vision. Frontiers in Neurorobotics, 15, 651432.
82. Pavlik, P. I., Cen, H., & Koedinger, K. R. (2009). Performance factors analysis-a new alternative to knowledge tracing. Paper presented at the Artificial intelligence in education.
83. Petrov, A., Dosher, B. A., & Lu, Z.-L. (2005). The dynamics of perceptual learning: an incremental reweighting model. Psychological review, 112(4), 715-743.
84. Quinonero-Candela, J., & Rasmussen, C. E. (2005). A unifying view of sparse approximate Gaussian process regression. Journal of machine learning research, 6(December), 1939-1959.
85. Rao, R. P. (1999). An optimal estimation approach to visual perception and learning. Vision research, 39(11), 1963-1989.
86. Ratcliff, R., Smith, P. L., Brown, S. D., & McKoon, G. (2016). Diffusion decision model: Current issues and history. Trends in cognitive sciences, 20(4), 260-281.
87. Ritter, S., Anderson, J. R., Koedinger, K. R., & Corbett, A. (2007). Cognitive Tutor: Applied research in mathematics education. Psychonomic bulletin & review, 14, 249-255.
88. Rohrer, D., & Taylor, K. (2006). The effects of overlearning and distributed practise on the retention of mathematics knowledge. Applied Cognitive Psychology: The Official Journal of the Society for Applied Research in Memory and Cognition, 20(9), 1209-1224.
89. Rosenkranz, S. C., Kaulen, B., Zimmermann, H. G., Bittner, A. K., Dorr, M., & Stellmann, J.-P. (2021). Validation of computer-adaptive contrast sensitivity as a tool to assess visual impairment in multiple sclerosis patients. Frontiers in neuroscience, 15, 591302.
90. Rouder, J. N., & Lu, J. (2005). An introduction to Bayesian hierarchical models with an application in the theory of signal detection. Psychonomic bulletin & review, 12(4), 573-604.
91. Rouder, J. N., Sun, D., Speckman, P. L., Lu, J., & Zhou, D. (2003). A hierarchical Bayesian statistical framework for response time distributions. Psychometrika, 68(4), 589-606.
92. Sagi, D. (2011). Perceptual learning in vision research. Vision research, 51(13), 1552-1566.
93. Schmitz-Valckenberg, S., Bultmann, S., Dreyhaupt, J., Bindewald, A., Holz, F. G., & Rohrschneider, K. (2004). Fundus autofluorescence and fundus perimetry in the junctional zone of geographic atrophy in patients with age-related macular degeneration. Investigative ophthalmology & visual science, 45(12), 4470-4476.
94. Shibata, K., Sasaki, Y., Bang, J. W., Walsh, E. G., Machizawa, M. G., Tamaki, M., . . . Watanabe, T. (2017). Overlearning hyperstabilizes a skill by rapidly making neurochemical processing inhibitory-dominant. Nature neuroscience, 20(3), 470-475.
95. Smith, S. D., Katz, J., & Quigley, H. A. (1996). Analysis of progressive change in automated visual fields in glaucoma. Investigative ophthalmology & visual science, 37(7), 1419-1428.
96. Snoddy, G. S. (1926). Learning and stability: a psychophysiological analysis of a case of motor learning with clinical applications. Journal of Applied Psychology, 10(1), 1.
97. Stellmann, J.-P., Young, K. L., Pottgen, J., Dorr, M., & Heesen, C. (2015). Introducing a new method to assess vision: computer-adaptive contrast-sensitivity testing predicts visual functioning better than charts in multiple sclerosis patients. Multiple Sclerosis Journal-Experimental, Translational and Clinical, 1, 2055217315596184.
98. Sweller, J., & Cooper, G. A. (1985). The use of worked examples as a substitute for problem solving in learning algebra. Cognition and instruction, 2(1), 59-89.
99. Tamaki, M., Wang, Z., Barnes-Diana, T., Guo, D., Berard, A. V., Walsh, E., . . . Sasaki, Y. (2020). Complementary contributions of non-REM and REM sleep to visual learning. Nature neuroscience, 23(9), 1150-1156.
100. Tang, C., Srivastava, N., & Salakhutdinov, R. R. (2014). Learning generative models with visual attention. Advances in Neural Information Processing Systems, 27.
101. Thomas, M., Silverman, R. F., Vingopoulos, F., Kasetty, M., Yu, G., Kim, E. L., . . . Kim, L. A. (2021). Active learning of contrast sensitivity to assess visual function in macula-off retinal detachment. Journal of VitreoRetinal Diseases, 5(4), 313-320.
102. Titsias, M. (2009). Variational learning of inducing variables in sparse Gaussian processes. Paper presented at the Artificial intelligence and statistics.
103. Torrence, C., & Compo, G. P. (1998). A practical guide to wavelet analysis. Bulletin of the American Meteorological society, 79(1), 61-78.
104. Townend, B. S., Sturm, J. W., Petsoglou, C., O'Leary, B., Whyte, S., & Crimmins, D. (2007). Perimetric homonymous visual field loss post-stroke. Journal of Clinical Neuroscience, 14(8), 754-756.
105. VanLehn, K. (2011). The relative effectiveness of human tutoring, intelligent tutoring systems, and other tutoring systems. Educational psychologist, 46(4), 197-221.
106. Vingopoulos, F., Bannerman, A., Zhou, P., Koch, T., Wescott, H. E., Kim, L., . . . Miller, J. B. (2024). Towards the validation of quantitative contrast sensitivity as a clinical endpoint: correlations with vision-related quality of life in bilateral AMD. British Journal of Ophthalmology, 108(6), 846-851.
107. Vingopoulos, F., Kasetty, M., Garg, I., Silverman, R. F., Katz, R., Vasan, R. A., . . . Miller, J. B. (2022). Active learning to characterize the full contrast sensitivity function in cataracts. Clinical Ophthalmology (Auckland, NZ), 16, 3109.
108. Vingopoulos, F., Wai, K. M., Katz, R., Vavvas, D. G., Kim, L. A., & Miller, J. B. (2021). Measuring the contrast sensitivity function in non-neovascular and neovascular age-related macular degeneration: the quantitative contrast sensitivity function test. Journal of Clinical Medicine, 10(13), 2768.
109. Watanabe, S., & Opper, M. (2010). Asymptotic equivalence of Bayes cross validation and widely applicable information criterion in singular learning theory. Journal of machine learning research, 11(12).
110. Watson, A. B. (1986). Temporal sensitivity. Handbook of perception and human performance. Vol. I: sensory processes and perception (Boff K, Kaufman L, Thomas J, eds). In: New York: Wiley.
111. Watson, A. B., & Ahumada, A. J. (2005). A standard model for foveal detection of spatial contrast. Journal of vision, 5(9), 6-6.
112. Wei, L., Meng, J., Cheng, K., He, W., Qi, J., Lu, Z.-L., . . . Zhu, X. (2022). Contrast sensitivity function: a more sensitive index for assessing protective effects of the cilioretinal artery on macular function in high myopia. Investigative ophthalmology & visual science, 63(13), 25-25.
113. Werner, E. B., Saheb, N., & Thomas, D. (1982). Variability of static visual threshold responses in patients with elevated IOPs. Archives of ophthalmology, 100(10), 1627-1631.
114. West, S. K., Rubin, G. S., Broman, A. T., Munoz, B., Bandeen-Roche, K., Turano, K., & Team, S. P. (2002). How does visual impairment affect performance on tasks of everyday life?: The SEE Project. Archives of ophthalmology, 120(6), 774-780.
115. Wilensky, J. T., & Joondeph, B. C. (1984). Variation in visual field measurements with an automated perimeter. American journal of ophthalmology, 97(3), 328-331.
116. Williams, C. K., & Rasmussen, C. E. (2006). Gaussian processes for machine learning (Vol. 2): MIT press Cambridge, MA.
117. Woodworth, R. S., & Thorndike, E. L. (1901). The influence of improvement in one mental function upon the efficiency of other functions.(I). Psychological review, 8(3), 247.
118. Xiao, L.-Q., Zhang, J.-Y., Wang, R., Klein, S. A., Levi, D. M., & Yu, C. (2008). Complete transfer of perceptual learning across retinal locations enabled by double training. Current Biology, 18(24), 1922-1926.
119. Xu, P., Lesmes, L. A., Yu, D., & Lu, Z.-L. (2019). A novel Bayesian adaptive method for mapping the visual field. Journal of vision, 19(14), 16-16.
120. Yang, J. (2020). General learning ability in perceptual learning. Proc. Natl Acad. Sci. USA, 117. doi:10.1073/pnas.2002903117
121. Yang, J., Yan, F.-F., Chen, L., Fan, S., Wu, Y., Jiang, L., . . . Lu, Z.-L. (2022). Identifying long- and short-term processes in perceptual learning. Psychological Science, 33, 830-843.
122. Yang, J., Yan, F.-F., Chen, L., Xi, J., Fan, S., Zhang, P., . . . Huang, C.-B. (2020). General learning ability in perceptual learning. Proceedings of the National Academy of Sciences, 117(32), 19092-19100.
123. Ye, Y., Aruma, A., Zhao, W., Lu, Z.-L., Zhou, X., & Zhao, J. (2023). A novel quick contrast sensitivity function test in Chinese adults with myopia and its related parameters. Graefe's archive for clinical and experimental ophthalmology, 261(7), 2071-2080.
124. Yildirim, I., Janner, M., Belledonne, M., Wallraven, C., Freiwald, W., & Tenenbaum, J. (2017). Causal and compositional generative models in online perception. Paper presented at the Proceedings of the Annual Meeting of the Cognitive Science Society.
125. Zeng, R., Vingopoulos, F., Wang, M., Bannerman, A., Wescott, H. E., Baldwin, G., . . . Kim, L. A. (2023). Structure-function association between contrast sensitivity and retinal thickness (total, regional, and individual retinal layer) in patients with idiopathic epiretinal membrane. Graefe's archive for clinical and experimental ophthalmology, 261(3), 631-639.
126. Zhang, P., Zhao, Y., Dosher, B. A., & Lu, Z.-L. (2019). Assessing the detailed time course of perceptual sensitivity change in perceptual learning. Journal of vision, 19(5), 9.
127. Zhao, Y., Lesmes, L. A., Dorr, M., & Lu, Z.-L. (2021). Quantifying uncertainty of the estimated visual acuity behavioral function with hierarchical Bayesian modeling. Translational Vision Science & Technology, 10(12), 18-18.
128. Zhao, Y., Lesmes, L. A., Dorr, M., & Lu, Z.-L. (2023). Collective endpoint of visual acuity and contrast sensitivity function from hierarchical Bayesian joint modeling. Journal of vision, 23(6), 13-13.
129. Zhao, Y., Lesmes, L. A., Dorr, M., & Lu, Z.-L. (2024). Using Hierarchical Bayesian Modeling to Enhance Statistical Inference on Contrast Sensitivity. Translational Vision Science & Technology, 13(12), 17-17.
130. Zhao, Y., Lesmes, L. A., Hou, F., & Lu, Z.-L. (2021). Hierarchical Bayesian modeling of contrast sensitivity functions in a within-subject design. Journal of vision, 21(12), 9-9.
131. Zhao, Y., Liu, J., Dosher, B. A., & Lu, Z.-L. (2024). Enabling identification of component processes in perceptual learning with nonparametric hierarchical Bayesian modeling. Journal of vision, 24(5), 8-8.
132. Fan, J., Liao, Y., & Mincheva, M. (2013). Large covariance estimation by thresholding principal orthogonal complements. Journal of the Royal Statistical Society Series B: Statistical Methodology, 75(4), 603-680.
133. Vono, M., Dobigeon, N., & Chainais, P. (2022). High-dimensional Gaussian sampling: A review and a unifying approach based on a stochastic proximal point algorithm. SIAM Review, 64(1), 3-56.
134. Wainwright, M. J., & Jordan, M. I. (2008). Graphical models, exponential families, and variational inference. Foundations and Trends® in Machine Learning, 1(1-2), 1-305.
135. Bühlmann, P., & Van De Geer, S. (2011). Statistics for high-dimensional data: methods, theory and applications: Springer Science & Business Media.
136. Alvarez, I., Niemi, J., & Simpson, M. (2014). Bayesian inference for a covariance matrix. arXiv preprint arXiv:1408.4050.
137. Müller, P., & Mitra, R. (2013). Bayesian nonparametric inference-why and how. Bayesian analysis (Online), 8(2), 10.1214/1213-BA1811.
138. Hoff, P. D., & Niu, X. (2012). A covariance regression model. Statistica sinica, 729-753.
139. Wang, H., & Pillai, N. S. (2013). On a class of shrinkage priors for covariance matrix estimation. Journal of Computational and Graphical Statistics, 22(3), 689-707.

What is claimed is:

1. A system for estimating at least one latent variable from data, comprising:
at least one processor configured to:
receive a plurality of measurement outcomes;
generate a multi-resolution pyramid structure having a plurality of layers at progressively finer resolutions based on the plurality of measurement outcomes, wherein a top layer of the multi-resolution pyramid structure represents a plurality of latent variables at a coarsest resolution;
electronically estimate, using a Bayesian inference framework, parameters at the top layer and deviation terms at one or more subsequent layers of the multi-resolution pyramid structure; and
electronically generate the at least one estimated latent variable of the plurality of latent variables at one or more resolutions based on the estimated parameters and the deviation terms.

2. The system of claim 1, wherein the multi-resolution pyramid structure comprises a parameter pyramid for coarse trends and a difference pyramid for fine-scale deviations, and wherein the at least one processor is further configured to iteratively combine the parameter pyramid and the difference pyramid to recover the at least one latent variable which is estimated at the one or more resolutions.

3. The system of claim 2, wherein the at least one processor is further configured to model a covariance among the parameters at the top layer of the parameter pyramid and to model variance without the covariance at the one or more subsequent layers using the difference pyramid.

4. The system of claim 2, wherein a number of blocks at each successive layer of the difference pyramid is doubled relative to a preceding layer of the parameter pyramid.

5. The system of claim 1, wherein the Bayesian inference framework comprises a hierarchical Bayesian model with a covariance at the top layer and a hierarchical Bayesian model with a variance at the one or more subsequent layers.

6. The system of claim 5, wherein the hierarchical Bayesian model with the covariance comprises a population level, a subject level, and a test level, and wherein the at least one processor is further configured to pool information across a plurality of subjects at the population level to reduce variance of the at least one estimated latent variable.

7. The system of claim 1, wherein the at least one processor is further configured to model each measurement outcome of the plurality of measurement outcomes as an outcome of a generative function driven by test conditions and the at least one estimated latent variable.

8. The system of claim 1, wherein the plurality of measurement outcomes comprises behavioral measurement outcomes from a plurality of subjects, and wherein the at least one latent variable comprises at least one of a perceptual learning threshold, a visual field sensitivity or a contrast sensitivity value.

9. The system of claim 1, wherein the at least one processor is further configured to cause a display arrangement to display the at least one estimated latent variable.

10. The system of claim 1, wherein the multi-resolution pyramid structure represents at least one of a one-dimensional discrete function or a two-dimensional discrete function.

11. A method for estimating at least one latent variable from data, comprising:
receiving, using at least one processor, a plurality of measurement outcomes;
constructing, using the at least one processor, a multi-resolution pyramid structure having a plurality of layers at progressively finer resolutions based on the plurality of measurement outcomes, wherein a top layer of the multi-resolution pyramid structure represents a plurality of latent variables at a coarsest resolution;
estimating, using the at least one processor and a Bayesian inference framework, parameters at the top layer and deviation terms at one or more subsequent layers of the multi-resolution pyramid structure; and
generating at least one estimated latent variable of the plurality of latent variables at one or more resolutions based on the estimated parameters and the deviation terms.

12. The method of claim 11, wherein the multi-resolution pyramid structure comprises a parameter pyramid for coarse trends and a difference pyramid for fine-scale deviations, and wherein the generating comprises iteratively combining the parameter pyramid and the difference pyramid to recover the at least one estimated latent variable which is estimate at the one or more resolutions.

13. The method of claim 12, wherein the estimating comprises modeling a covariance among the parameters at the top layer of the parameter pyramid and a modeling variance without the covariance at the one or more subsequent layers using the difference pyramid.

14. The method of claim 12, wherein a number of blocks at each successive layer of the difference pyramid doubles relative to a preceding layer of the parameter pyramid.

15. The method of claim 11, wherein the Bayesian inference framework comprises a hierarchical Bayesian model with a covariance at the top layer and a hierarchical Bayesian model with a variance at the one or more subsequent layers.

16. The method of claim 15, wherein the hierarchical Bayesian model with the covariance comprises a population level, a subject level, and a test level, and wherein the estimating further comprises pooling information across a plurality of subjects at the population level to reduce variance of the at least one estimated latent variable.

17. The method of claim 11, wherein the estimating further comprises modeling each measurement outcome of the plurality of measurement outcomes as an outcome of a generative function driven by test conditions and the at least one estimated latent variable.

18. The method of claim 11, wherein the plurality of measurement outcomes comprises behavioral measurement outcomes from a plurality of subjects, and wherein the at least one latent variable comprises at least one of a perceptual learning threshold, a visual field sensitivity, or a contrast sensitivity value.

19. The method of claim 11, further comprising causing a display arrangement to display the at least one estimated latent variable.

20. A non-transitory computer-accessible medium containing executable instructions for estimating at least one latent variable from data, wherein, when the executable instructions are executed by at least one processor, the at least one processor is configured to perform a procedure comprising:
receiving a plurality of measurement outcomes;
constructing a multi-resolution pyramid structure having a plurality of layers at progressively finer resolutions based on the plurality of measurement outcomes, wherein a top layer of the multi-resolution pyramid structure represents a plurality of latent variables at a coarsest resolution;
estimating, using a Bayesian inference framework, parameters at the top layer and deviation terms at one or more subsequent layers of the multi-resolution pyramid structure; and
generating at least one estimated latent variable of the plurality of latent variables at one or more resolutions based on the estimated parameters and the deviation terms.
